(19) United States
(12) Patent Application Publication
(10) Pub. No.: US 2009/0278641 A1
(43) Pub. Date: Nov. 12, 2009

(54) Cylinder Position Sensor and Cylinder Incorporating the Same

(75) Inventor: Kayvan Hedayat, Weston, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: STONERIDGE CONTROL DEVICES, INC., Canton, MA (US)

(21) Appl. No.: 12/468,860

(22) Filed: May 19, 2009

Related U.S. Application Data
(63) Continuation-in-part of application No. 11/956,302, filed on Dec. 13, 2007.
(60) Provisional application No. 61/054,265, filed on May 19, 2008.
(60) Provisional application No. 60/869,805, filed on Dec. 13, 2006.
(60) Provisional application No. 60/871,622, filed on Dec. 22, 2006.
(60) Provisional application No. 60/916,000, filed on May 4, 2007.
(60) Provisional application No. 60/975,328, filed on Sep. 26, 2007.

(51) Int. Cl. H01F 13/00

(52) U.S. Cl. 335/284

(57) ABSTRACT

A cylinder position sensor system including a cylinder barrel; a piston disposed within the cylinder barrel; a piston rod coupled to the piston, at least one magnet coupled to the piston; and at least one sense element positioned outside of the piston barrel. The magnet establishes a field sensed by the sense element for providing an indication of the position of the piston.

### CROSS-REFERENCE TO RELATED APPLICATIONS

The present application claims the benefit of the filing date of U.S. Provisional Patent Application Ser. No. 61/054,265, filed May 19, 2008 and is a continuation-in-part of U.S. patent application Ser. No. 11/956,302, filed Dec. 13, 2007, which claims the benefit of the filing dates of U.S. Provisional Application Ser. No. 60/869,805, filed Dec. 13, 2006, U.S. Provisional Application Ser. No. 60/871,622, filed Dec. 22, 2006, U.S. Provisional Application Ser. No. 60/916,000, filed May 4, 2007, and U.S. Provisional Application Ser. No. 60/975,328, filed Sep. 26, 2007, the entire teachings of which applications are hereby incorporated herein by reference.

### TECHNICAL FIELD

The present disclosure relates generally position sensors, and more particularly position sensors for use with cylinders.

### BACKGROUND

The use of actuators to control the position and movement of one component relative to another component are well known. Many actuators (such as hydraulic cylinders, pneumatic cylinders, and the like) include a cylinder and a piston rod having a piston coupled thereto. The cylinder and piston/rod move with respect to each other when an actuating force (such as, but not limited to, pressurized hydraulic fluid or compressed air) is introduced.

In many applications, it may be desirable to know the position of the rod with respect to the cylinder. Control of the position of the rod is generally fundamental to controlling the operation of the machinery. Measuring the absolute position or velocity of the rod relative to the cylinder may often be required for achieving such control using conventional feedback control techniques.

### BRIEF DESCRIPTION OF THE DRAWINGS

Reference should be made to the following detailed description which should be read in conjunction with the following figures, wherein like numerals represent like parts:

FIG. 1 illustrates one exemplary embodiment of a system consistent with the present disclosure.

FIG. 2 illustrates an exemplary piston rod including one exemplary arrangement of permanent magnets and sense elements consistent with the present disclosure.

FIG. 3 is a plot of sensed field vs. rod stroke/position associated with the embodiment shown in FIG. 2.

FIG. 4 illustrates another exemplary piston rod including an exemplary arrangement of permanent magnets, sense elements and a demagnetizing coil consistent with the present disclosure.

FIG. 5 illustrates another exemplary piston rod including an exemplary arrangement of permanent magnets and sense elements consistent with the present disclosure.

FIG. 6 is a cross-sectional view of the embodiment illustrated in FIG. 5.

FIG. 7 illustrates another exemplary piston rod including an exemplary arrangement of permanent magnets consistent with the present disclosure.

FIG. 8 is a plot of sensed field vs. rod stroke/position associated with an exemplary cylinder position sensor consistent with the present disclosure.

FIG. 9 illustrates another exemplary cylinder consistent with the present disclosure.

FIG. 10 is a sectional view of the embodiment illustrated in FIG. 9 showing positioning of permanent magnets.

FIGS. 11A-11D diagrammatically illustrate radial, straight, and axial magnetizations of permanent magnets consistent with the present disclosure.

FIG. 12 illustrates another exemplary cylinder consistent with the present disclosure.

FIG. 13 is an end view of the embodiment illustrated in FIG. 12 showing positioning of permanent magnets.

FIG. 14 illustrates another exemplary cylinder consistent with the present disclosure.

FIG. 15 is an end view of the embodiment illustrated in FIG. 14 showing positioning of permanent magnets.

FIG. 16 illustrates another exemplary cylinder consistent with the present disclosure.

FIG. 17 is an end view of the embodiment illustrated in FIG. 16 showing positioning of permanent magnets.

FIG. 18 is a detailed view of an end portion of the rod illustrated in FIG. 16.

FIG. 19 illustrates another exemplary cylinder consistent with the present disclosure.

FIG. 20 illustrates a closed loop magnetic flux path in an exemplary cylinder consistent with the present disclosure.

FIG. 21 illustrates a portion of a cylinder consistent with the present disclosure including a permanent magnet disposed in cavity formed in a rod.

FIG. 22 illustrates a portion of a cylinder consistent with the present disclosure including a permanent magnet disposed in nut for securing a piston to a rod.

FIG. 23 is an end view of the nut illustrated in FIG. 22.

FIG. 24 illustrates another exemplary cylinder consistent with the present disclosure.

FIG. 25 is an end view of the embodiment illustrated in FIG. 24.

FIG. 26 illustrates another exemplary cylinder consistent with the present disclosure.

FIG. 27 is an end view of the embodiment illustrated in FIG. 26.

FIG. 28 illustrates another exemplary cylinder consistent with the present disclosure.

FIG. 29 is an end view of the embodiment illustrated in FIG. 28.

FIG. 30 illustrates another exemplary cylinder consistent with the present disclosure.

FIG. 31 illustrates another exemplary cylinder consistent with the present disclosure.

FIG. 32 is an end view of the embodiment illustrated in FIG. 31.

FIG. 33 is a detailed view of an end portion of the rod illustrated in FIG. 31.

FIG. 34 illustrates another exemplary cylinder consistent with the present disclosure.

FIG. 35 diagrammatically illustrates one exemplary arrangement of sense elements in a system consistent with the present disclosure.

FIG. 36 is a side view of the embodiment shown in FIG. 35.

FIG. 37 diagrammatically illustrates another exemplary arrangement of sense elements in a system consistent with the present disclosure.

FIG. 38 is a side view of the embodiment shown in FIG. 37.

FIG. 39 illustrates an exemplary embodiment of sensor electronics useful in a system consistent with the present disclosure.

FIG. 40 is a plot of output voltage vs. cylinder position associated the sensor electronics illustrated in FIG. 39.

FIG. 41 is a side view of another exemplary cylinder consistent with the present disclosure.

FIG. 42 is a sectional view of a portion of the cylinder illustrated in FIG. 41.

FIG. 43 is a side view of another exemplary cylinder consistent with the present disclosure.

FIG. 44 is a side view of another exemplary cylinder consistent with the present disclosure.

FIG. 45 is a perspective view of another exemplary cylinder consistent with the present disclosure including a shield.

FIG. 46 is a perspective view of an exemplary piston useful in a cylinder consistent with the present disclosure.

FIG. 47 is perspective view of the piston illustrated in FIG. 46 with a shield portion removed.

FIG. 48 is an exploded view of another exemplary piston useful in a cylinder consistent with the present disclosure.

FIG. 49 is a partially exploded view of the piston illustrated in FIG. 48.

FIG. 50 is a sectional view of the piston illustrated in FIG. 48.

FIG. 51 is another sectional view of the piston illustrated in FIG. 48.

FIG. 52 includes plots of the sensed radial field vs. rod stroke/position associated with an exemplary cylinder position sensor consistent with the present disclosure.

FIG. 53 includes plots of the sensed axial field vs. rod stroke/position associated with an exemplary cylinder position sensor consistent with the present disclosure.

FIG. 54 is an exploded view of a magnet assembly useful in a piston consistent with the present disclosure.

FIG. 55 is a partially exploded view of exemplary piston incorporating the magnet assembly illustrated in FIG. 54.

FIG. 56 is a perspective view of another exemplary piston useful in a cylinder consistent with the present disclosure.

FIG. 57 is a perspective view of another exemplary piston useful in a cylinder consistent with the present disclosure.

FIG. 58 is an exploded view of another exemplary piston useful in a cylinder consistent with the present disclosure.

FIG. 59 is a perspective view of the piston illustrated in FIG. 58.

FIG. 60 illustrates another exemplary embodiment of sensor electronics useful in a system consistent with the present disclosure.

FIG. 61 is a plot of sensor output vs. cylinder position associated the sensor electronics illustrated in FIG. 60.

FIG. 62 is a plot of output voltage vs. cylinder position associated the sensor electronics illustrated in FIG. 60.

FIG. 63 diagrammatically illustrates another exemplary arrangement of sense elements in a system consistent with the present disclosure.

FIG. 64 includes a plot of sensed magnetic field vs. cylinder position associated with an arrangement of sense elements consistent with FIG. 63.

FIG. 65 includes a plot the arctangent of sine/cosine outputs associated with an arrangement of sense elements consistent with FIG. 63.

FIG. 66 includes plots of sensed magnetic field vs. cylinder position associated with an arrangement of sense elements consistent with FIG. 63.

FIG. 67 includes plots of the derivative of the sensed magnetic field vs. cylinder position associated with an arrangement of sense elements consistent with FIG. 63.

FIG. 68 is a side perspective view of another exemplary cylinder consistent with the present disclosure.

FIG. 69 is a sectional view of a portion of the cylinder illustrated in FIG. 68.

FIG. 70 is an end view of the cylinder illustrated in FIG. 68.

FIG. 71 is a perspective view of a sense element and PCB assembly of the cylinder illustrated in FIG. 68.

FIG. 72 is a perspective view of an exemplary piston useful in a cylinder consistent with the present disclosure with a shield portion removed.

FIG. 73 is perspective view of the piston illustrated in FIG. 72.

FIG. 74 illustrates an exemplary arrangement of first and second sense elements for sensing a radial field in a cylinder as shown in FIG. 68;

FIGS. 75-77 include plots of the sensed radial field vs. rod stroke/position associated with the exemplary cylinder position sensor arrangement shown in FIG. 74.

FIG. 78 illustrates an exemplary arrangement of first and second sense elements for sensing an axial field in a cylinder as shown in FIG. 68;

FIGS. 79-81 include plots of the sensed axial field vs. rod stroke/position associated with the exemplary cylinder position sensor arrangement shown in FIG. 78.

FIG. 82 is a side perspective view of another exemplary cylinder consistent with the present disclosure.

FIG. 83 is a partial axial sectional view of the embodiment shown in FIG. 82.

FIG. 84 is a partial radial sectional view of the embodiment shown in FIG. 83 taken along lines A-A.

FIG. 85 is a sectional view of another exemplary piston assembly consistent with the present disclosure.

FIG. 86 is a sectional view of another magnet holder configuration consistent with the present disclosure.

FIG. 87 is a sectional view of the magnet holder shown in FIG. 86.

FIG. 88 is a sectional view of another magnet holder configuration consistent with the present disclosure.

FIG. 89 is a sectional view of the magnet holder shown in FIG. 88.

FIG. 90 is a sectional view of another magnet holder configuration consistent with the present disclosure.

FIG. 91 is a sectional view of the magnet holder shown in FIG. 90.

FIG. 92 is a sectional view of another piston assembly consistent with the present disclosure.

FIG. 93 is a sectional view of the piston assembly shown in FIG. 92

FIGS. 94-102 are sectional views of different magnet holder and magnet configurations consistent with the present disclosure.

FIG. 103 is a perspective view of another exemplary piston assembly consistent with the present disclosure.

FIG. 104 is a sectional view of the piston assembly shown in FIG. 103.

FIG. 105 is another sectional view of the piston assembly shown in FIG. 103.

FIG. 106 is a partial axial sectional view of another exemplary cylinder consistent with the present disclosure.

### DETAILED DESCRIPTION

Consistent with the present disclosure, various embodiments of cylinder position sensor systems are shown for determining position of a piston rod and elements coupled thereto. The cylinder may include any cylinder design known to those skilled in the art such as, but not limited to, hydraulic and pneumatic piston actuators and the like including at least one cylinder barrel and at least one rod/piston which are moved relative to each other by way of an actuator fluid (for example, but not limited to, hydraulic fluid or compressed air). Those skilled in the art will recognize that the cylinder position sensor systems consistent with the present disclosure will be useful in other applications as well.

As will be explained in greater detail, the cylinder position sensor systems described herein may include the use of one or more sensing elements that output a signal that may be utilized to determine/estimate the position of the cylinder rod. While not an exhaustive list, the sensing element may comprise one or more of Hall effect sensors, fluxgate sensors, MR sensors, GMR sensors, or any other magnetic sensor. As is known, a digital Hall effect sensor may be configured to provide a digital signal wherein the output may comprise a digital “1” output when in the presence of a predetermined level of magnetic flux and a digital “0” when the predetermined level of flux is absent. Of course, the value of the output signal could be also be reversed. Alternatively, the output of the sensor may comprise an analog signal. For the sake of brevity and clarity, the cylinder portion of the cylinder position sensor systems may not be completely illustrated and is considered within the knowledge of one of ordinary skill in the art.

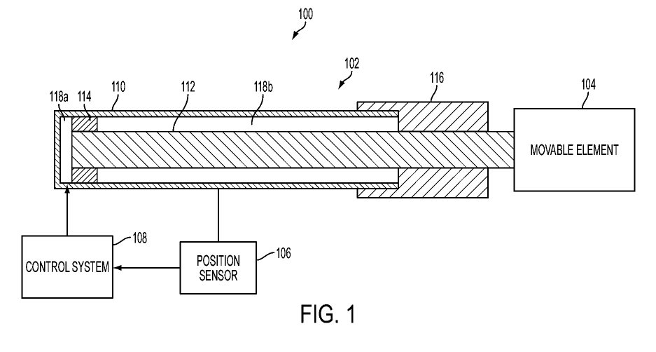

FIG. 1 illustrates an exemplary system consistent with the present disclosure including a cylinder 102 for moving a movable element 104, a position sensor 106, and a control system 108. The cylinder 102 is illustrated cross-sectional view and includes a cylinder barrel 110, a rod 112, a piston 114, and a rod guide 116. The piston 114 is arranged within the cylinder barrel 110 for reciprocating motion along the longitudinal axis of the barrel. The piston 114 partitions the cylinder barrel 110 into two chambers 118a and 118b. The piston, rod, barrel and/or rod guide may be made from a ferrous or non-ferrous material, e.g. steel.

One end of the piston rod 112 is secured to the piston 114. The rod extends along the axis of motion. The other end of piston rod 112 extends out of the barrel 110 through the rod guide 116, and may be coupled directly or indirectly to the movable element 104. In a known manner, the cylinder barrel may include channels (not shown) for introduction and extraction of fluid from the chambers 118a and 118b. Changes in fluid pressure applied in the chambers, e.g. through known fluid control mechanisms and couplings to the cylinder, cause corresponding movement of the piston and rod with respect to the cylinder barrel for causing controlled movement of the moveable element.

To provide controlled motion of the movable element, the position sensor 106 may be coupled to the cylinder 102 for sensing the position of the piston rod 112. The position sensor may provide an output to the control system indicating the position of the piston rod 112. The control system may control the motion of the piston rod, e.g. by control of the amount of fluid introduced into chambers 118a and 118b, in response to the output of the position sensor.

The movable element may be any element configured to be moved by a piston, e.g. a bucket portion of a loader, excavator, etc. In one embodiment, for example, a position sensor consistent with the present disclosure may be used in return to dig/return to dump applications. For example, an operator on a loader or excavator that is loading a pile of material to a dump truck or other carrier may set a dig point to have the bucket enter the pile and a dump point over the carrier. The dig and dump points may be determined from the sensor output. The operator may focus on placing the machine in the right place while the hydraulic system moves the bucket to the correct dig or dump height, as determined from the sensor output provided to the control system 108.

In another embodiment, in conjunction with an enhanced GPS system the hydraulics system may take inputs from the sensor and a computer model of a site grading plan or trench plan. The control system 108 may control positioning of an implement, e.g. a bucket, in response to the inputs to make the grade or trench run correctly without secondary finishing.

In another embodiment, an operator in a tractor may set a variety of implement variables including depth, rate of application, and others to process a pass through a field. At the end of the row, a button or other control may be used to pull all the implements away from the ground to turn around. Returning to the field, the operator may use a single control to return all of the hydraulically operated implement settings to the same point as before, using the sensor output to the control system 108, and process a row in the opposite direction.

In another embodiment, positioning an auger over a carrier that tracks beside a harvester may be critical since if the auger is misplaced grain can miss the carrier and be spoiled. In addition, the ability to have the auger oscillate while remaining over the carrier and fill the carrier more completely makes operation more efficient. The control system 108 may position the auger in the appropriate position and/or oscillate the auger in response to auger position information provided by a sensor consistent with the present disclosure.

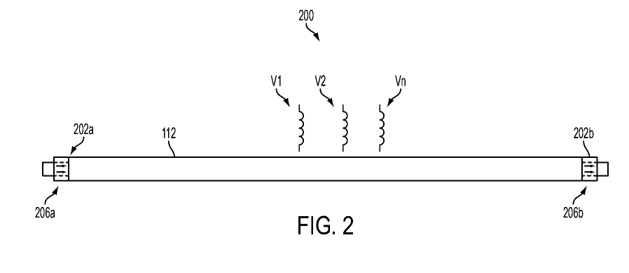

Turning now to FIG. 2, there is illustrated one exemplary embodiment of a cylinder position sensor consistent with the present disclosure, wherein at least one permanent magnet 202 (for example, a pair of permanent magnets 202a and 202b) are attached or otherwise secured to the rod 112 (for example, but not limited to, the end regions 206a and 206b of the rod 112) and move with the rod 24. One or more sensing elements 920-1, 920-2 . . . 920n may generate signals representative of the radial and/or tangential component of the magnetic field generated by the permanent magnets 202 and may be used to determine the position of the rod 112. In particular, as the magnets 202a and 202b move closer to the sensors 920, the sensor output may increase e.g. in a linear manner, and, as they away from the sensors, the sensor output may decrease, e.g. in a linear manner. The sensor outputs thus provide an indication of the position of the piston and rod with respect to the cylinder barrel.

According to one embodiment, the cylinder position sensor system 200 includes one or more ring permanent magnets 202a, 202b which may be attached to one or more of the ends 206a and 206b of the rod 112. Although not a limitation of the present disclosure unless specifically claimed as such, a ring permanent magnet 202 is preferred since it may clear the bolt (not shown) on the rod 112. The permanent magnets 202 may, however, be provided in any other shape or configuration known to those skilled in the art including, but not limited to, a permanent disc magnet and the like.

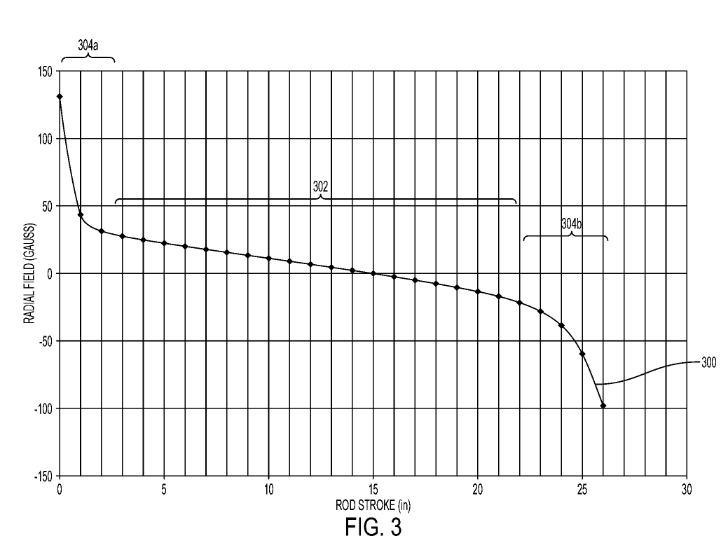

Referring to FIG. 3, a plot 300 of the radial output of one or more sensing elements 920 vs. rod stroke for a cylinder position sensor system 200 is shown. As shown, the sensor output for the system 200 may exhibit a substantially linear range 302 that may be used to determine the position of the rod. The non-linear regions 304a, 304b proximate the ends may also be linearized with sensor electronics and look up tables.

In some applications, a cylinder position sensor system 200 capable of high resolution (for example, 1 mm resolution) is required and/or desired. While this requirement may be relatively easy to meet for cylinder position sensor systems 200 used with relatively short rods 112, it may become more difficult for cylinder position sensor system 200 used with longer rods 112. For example, a cylinder position sensor system 200 may be required to exhibit a resolution of one into 2000 parts for a rod 112 which is 2 meters long (2000 mm) in order to maintain a 1 mm resolution. While higher resolution sensing elements 920 (such as Hall sensors) may be available, many sensing elements may not have high enough resolution for 2 meter rod. For illustrative purposes only, a typical Hall sensor 920 may deliver a 10 bit resolution (one in 1024).

For applications where a cylinder position sensor system 200 with a higher resolution is desired, the cylinder position sensor system 200 may include two or more sensors 920-1, 920-2 . . . 920n where each sensing element 920-1, 920-2 . . . 920n measures a portion of the length of the rod 112 and then the next sensing element 920-1, 920-2 . . . 920n takes over. These sensing elements 920-1, 920-2 . . . 920n may operate at different gains.

One potential issue with any cylinder position sensor system is susceptibility to the effects of external magnetic fields such as those generated by cow magnets. Cow magnets are used in the agricultural industry and are fed to a cow to sit in the cow's first stomach. The cow magnet collects sharp objects like nails and the like to prevent injury to cow's internal organs. Because of this, farmers often have cow magnets in their pockets in the field. When a cow magnet comes in contact with the rod 112 of a cylinder position sensor system, the cow magnet may distort the sensed field and disrupt accurate position sensing.

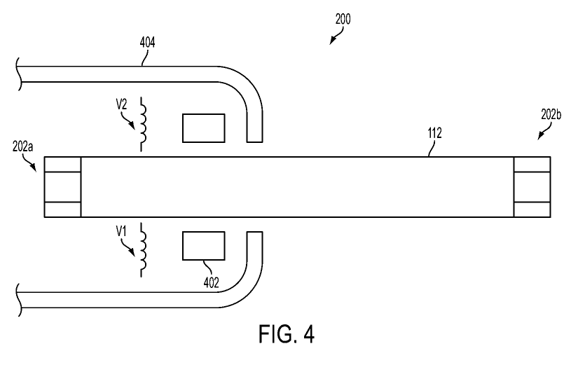

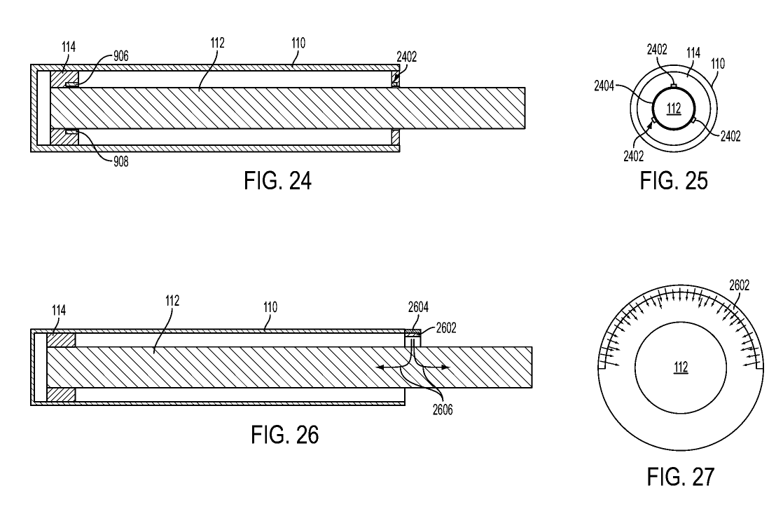

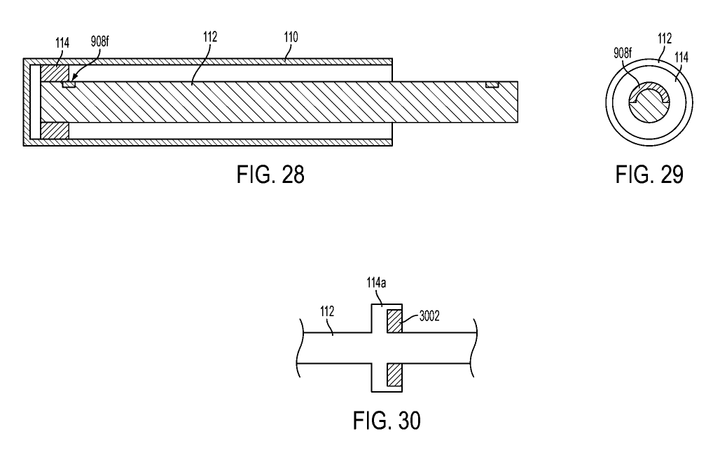

In a cylinder position sensor system 200, when a cow magnet comes in contact with the rod 112 (having magnets 202a and 202b attached at either end 206a or 206b), or the rod is placed in an external magnetic field, there may be a residual magnetic field after the cow magnet or external field is removed. This residual field may distort the position information. To address this, a de-magnetization coil 402, as shown in FIG. 4, may be incorporated into the sensor element housing 404 or around the rod 112. The demagnetization coil 402 may be energized at a fixed sinusoidal frequency to de-magnetize the rod 112 before the sensing sensor(s) 920-1, 920-2 register the position information. The position sensor electronics may reject any AC component and therefore read the DC portion of the field which is due to the permanent magnet 202a and 202b only. Most hydraulic cylinders are made from ferromagnetic materials which is desirable (but not necessary) for the magnetic sensor. Alternatively, as described below in connection with FIG. 24, permanent magnets can be used as magnetic erasers to remove or reduce residual magnetic fields as the rod moves and before the sensors picks up the main magnetic field from the source permanent magnets.

Another potential issue with a cylinder position sensor system is that the rod 112 may bend due to loads exerted on the cylinder during operation. Bending of the rod 112 may alter the air gap/spacing between the sensing elements 920 and the rod 112, which in turn may change the output of the sensing elements 920. To address this, a plurality of sensing elements 920 (for example, multiple sensing elements 920 substantially equally spaced around the circumference of the rod 12, for example at approximately 180 degrees apart) may be used to substantially cancel the effect due to the bending of the rod 12. As one sensing elements 920-1 gets closer to the rod 112 due to bending, another sensing elements 920-2 (for example at 180 degrees with respect to the first sensing elements 920-1), will become further from the rod 112. The output of these sensing elements 920 may be added (for example, through differential connection and the like) which may result in substantially canceling the bending error or any constant external field that may enter the cylinder.

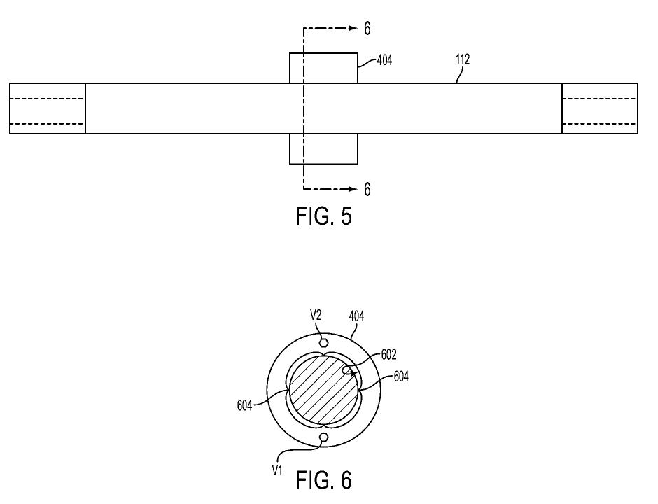

Additionally or alternatively, the effects of the bending of the rod 112 may be addressed by “floating” the sensing elements 920. As shown, for example, in FIGS. 5 and 6, the sensor housing 404 may be coupled to the rod 112 and may radially move with the rod 12. One or more sensing elements 920 may be coupled to the sensor housing 404. The sensor housing 404 may include comprise an inner surface 602 having a plurality of ribs 604 (for example, three of more ribs 604) which contact the outer surface of the rod 112 and substantially maintain/fix the spacing/distance between the sensing elements 920 and the rod 112. As the rod 12 bends, the sensor housing 404 may move with the rod 12 and the effective air gap/spacing between the sensing elements 920 and the rod 112 may remain substantially constant.

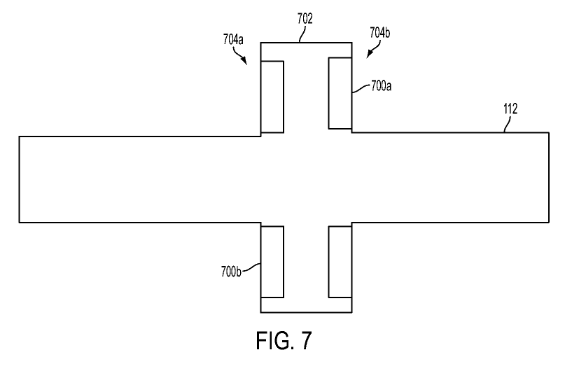

The location of the permanent magnets used for generating the field to be sensed by the sensing elements 920 may vary depending on the application. For example, some cylinders which are double acting may accommodate a magnet in the center of the cylinder. As shown in FIG. 7, for example, permanent magnets 700a, 700b may be embedded inside the rod 112 to further close the magnetic path and also minimize the amount of extension of the rod 112 due to the addition of magnets 700a, 700b. For example, the rod 112 may include a shoulder or step region 702 extending generally radially outwardly from the rod 112. One or more magnets 700a, 700b (for example, but not limited to, ring magnets) may be located on each side/face 704a and 704b of the shoulder 702.

According to yet another embodiment, instead of, or in addition to, the permanent magnets the rod may include a magnetically hard magnetic coating on the shaft to create a more stable output against external magnetic fields. The hard magnetic coating may not work in the presence of external fields since the steel does much of the magnetic work due to its large mass under the thin plating material and an external field (for example, a cow magnet or the like) may magnetize the steel under the plating and change the sensor output. Additionally, the plating material itself may become de-magnetized in the presence of fields larger than its coercivity (Hc).

According to one embodiment, the present disclosure may address these issues by demagnetizing the rod while the sensor is operating. The demagnetizing field may be strong enough to de-magnetize the steel, but weak enough so it does not de-magnetize the plating material. As such, the issue of steel being magnetized may be resolved if the plating is selected to have a sufficiently hard (magnetically speaking) magnetic plating in combination with the demagnetization of the rod (for example, using the demagnetization coil or permanent eraser magnets discussed above).

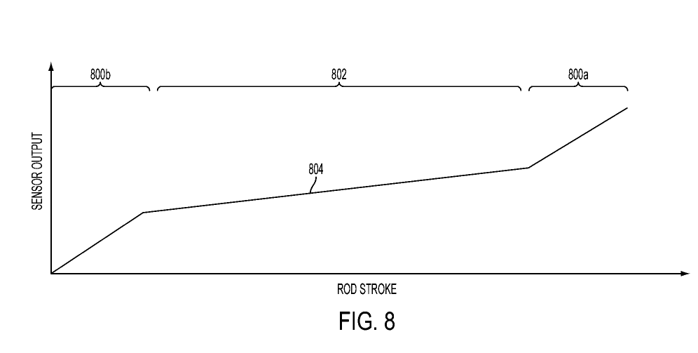

Although high resolution may be generally desired in many applications, high resolution may only be needed in certain areas of travel along the length of the cylinder. Accordingly, any of the cylinder position sensor system embodiments described herein may have one or more regions of high position sensing resolution and one or more regions of low resolution. FIG. 8, for example, is a plot 804 of sensor output vs. rod stroke for an exemplary cylinder position sensor consistent with the present disclosure. The plot 804 exhibits first 800a and second 800b high position sensing resolution regions having relatively high slope compared to a low position sensing resolution region 802. High position sensing resolution may be achieved, as described above, by placing more sensing elements adjacent a portion of the rod where high resolution is desired, compared to where low resolution is desired.

A cylinder position sensor consistent with the present disclosure, therefore, may include one or more magnets attached to a cylinder rod to produce a magnetic field that establishes a substantially linear output from one or more sense elements to indicate rod position. Radial, axial and/or tangential field components may be sensed by the sensing elements to identify rod position. A demagnetizing pulse and/or permanent magnets may be used to magnetically polish the rod to removing any residual magnetic fields.

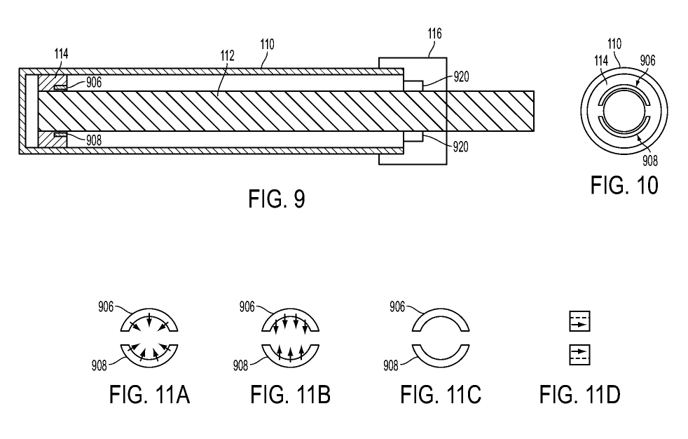

FIG. 9 illustrates another embodiment of a cylinder positions sensor consistent with the present disclosure. The exemplary embodiment illustrated in FIG. 9 shows a portion of a hydraulic cylinder including a sensor configuration consistent with the present disclosure. Again, those of ordinary skill in the art will recognize that the hydraulic cylinder is illustrated in simplified form for ease of explanation.

In the embodiment of FIGS. 9 and 10, magnets 906, 908 are provided in pockets formed in the piston 114. The magnets 906 and 908 are semi-circular and are positioned in corresponding semi-circular pockets in the piston to be disposed around a portion of the circumference of the rod 112. It is to be understood, however, that any number of magnets may be used. For example, a plurality of smaller magnets may be disposed around all or a portion of the circumference of the piston, or a single circular magnet may be used. The magnets may be comprised on any magnetic material, sufficient for establishing sensible magnetic flux through the sensors in the application. In one embodiment, the magnets may be neodymium magnets. Traditionally sintered magnets may be used.

The magnets may be magnetized in radial, straight or axial directions. The arrows in FIGS. 11A and 11B, respectively, for example illustrate radial and straight magnetization of the magnets 906 and 908. FIG. 11C is a front view of the magnets 906 and 908, and the arrows in the sectional view of FIG. 11D illustrate an axial magnetization of the magnets in FIG. 11C. A straight magnetization as illustrated in FIG. 11B may be simpler with traditionally sintered magnets. One or more sensors 920, e.g. flux gate sensors, for sensing magnetic flux may be positioned adjacent the end of the cylinder, e.g. in associated slots in the cylinder rod guide 116 or in a separate sensor housing coupled around the rod.

As shown, for example in FIG. 20 magnetic flux from the magnets 906 and 908 may have a closed loop path through the piston rod 112, the rod guide 116 (or other element housing the sensors), barrel 110 and returning to the magnets through the piston 114. The sensors 920 may be disposed within or adjacent to the flux path for sensing at least a portion of the magnetic flux and provide an output indicative of the level of flux passing therethrough. As the piston and rod move closer to the sensors 920, the sensor output may increase e.g. in a substantially linear manner, and, as the piston and rod move away from the sensors, the sensor output may decrease, e.g. in a substantially linear manner. The sensor outputs thus provide an indication of the position of the piston and rod with respect to the cylinder barrel. In the exemplary embodiments described herein, the sensors and sensor housing or rod guide may be omitted for ease of illustration.

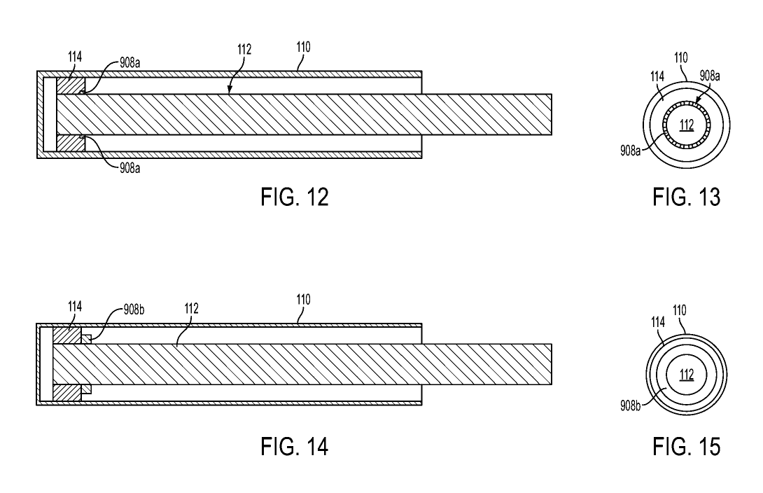

The magnets may be coupled to the piston or rod, directly or indirectly, at any location and in a variety of configurations. FIGS. 12-18 illustrate exemplary alternative magnet configurations. FIGS. 12-13 illustrate a plurality of magnets 908a positioned in the piston 114 and in direct contact with the rod 112. FIGS. 14-15 illustrate a single ring magnet 908b positioned adjacent the exterior surface of the piston 114.

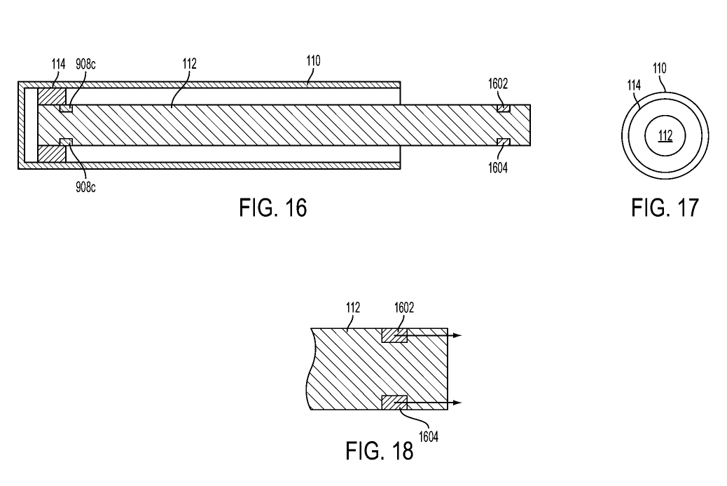

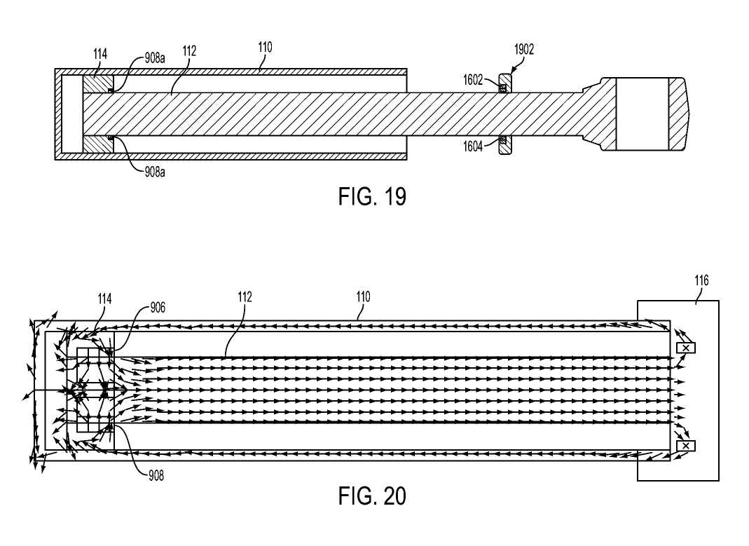

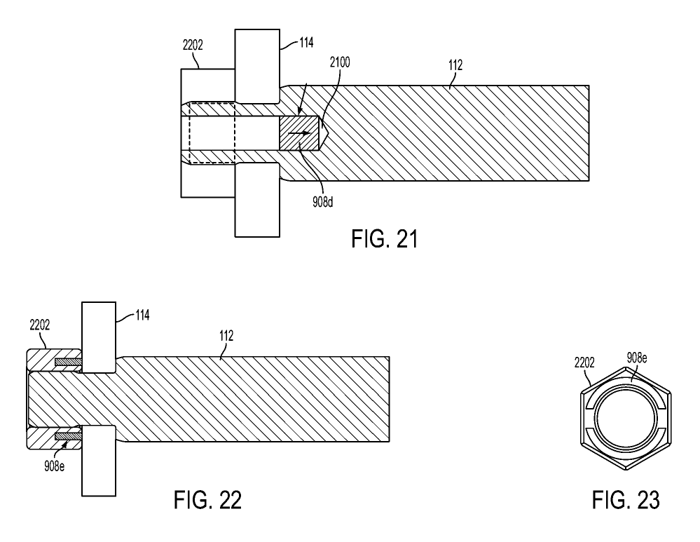

FIGS. 16-18 illustrate one or more magnets 908c assembled into the rod. As shown in FIGS. 16 and 18 one or more rod magnets 1602, 1604 may also or alternatively be positioned in the rod 112 adjacent an end opposite the piston, e.g. beyond the end of the cylinder and sensor positions. In the embodiment of FIG. 16, the magnets are magnetized in direction parallel to the axis of the rod 112, as indicated by the arrows in FIG. 18. As shown in FIG. 19, the rod magnets 1602, 1604 may be coupled to the rod using a magnet holder 1902. The magnet holder may be constructed from steel or a non-ferrous material. FIGS. 21 and 22-23 illustrate additional magnet mounting locations. As shown in FIG. 21, one or more magnets 908d may be mounted in a bore 210 in the rod 112. As shown in FIGS. 22-23, one or more magnets 908e may be mounted in a nut 2202 for coupling the piston 114 to the rod 112.

FIGS. 24-25 illustrate one exemplary embodiment of a sensor system consistent with the present disclosure including one or more eraser magnets 2402 positioned adjacent the end of the cylinder barrel 110. As shown, a plurality of permanent magnets 2402 may be held in place around the circumference of the rod 112 by an eraser magnet holder 2404. The eraser magnets 2402 may remove residual magnetic fields as the rod moves and before the sensors pick up the main magnetic field from the source permanent magnets. The eraser magnets may be magnetized in a direction to away from the sensors to provide a bias against external fields, e.g. resulting from a cow magnet or other permanent magnet placed on or adjacent to the rod.

Permanent magnets for establishing a sensible field for determining rod position may be provided in additional or alternative locations. As shown for example in FIG. 26 a cylinder position sensor consistent with the present disclosure may operate using a fixed magnet 2602. In the illustrated exemplary embodiment, the fixed magnet is positioned on a shield extension 2604 extending axially from the end of the barrel 110 to provide flux indicated by arrows 2606. Flux from the fixed magnet 2602 may be sensed to determined cylinder position and may also provide a bias against external fields.

As shown for example in FIG. 28-29, a permanent magnet 908f in a cylinder position sensor consistent with the present disclosure may be positioned around only a portion of the circumference of the rod 112, e.g. to reduce costs in embodiments where the rod does not rotate. Also, FIG. 30 illustrates an arrangement including a magnet 3002 coupled to a piston 114a, e.g. in a central location of the rod 112, for a double acting rod configuration.

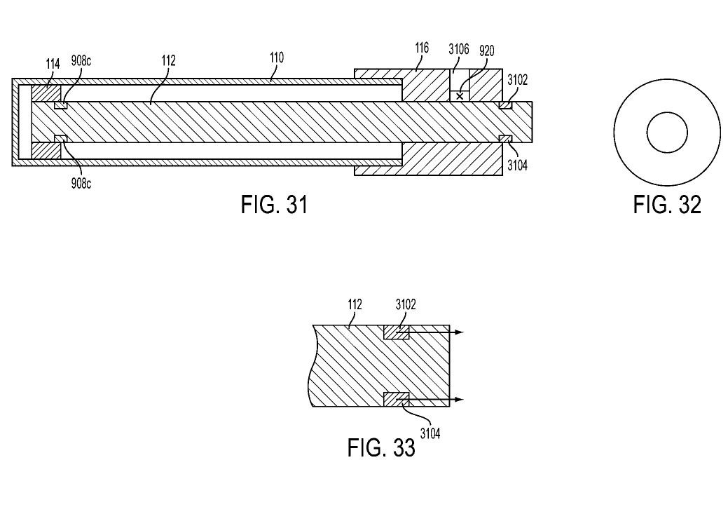

As shown in FIGS. 31-33 one or more rod magnets 3102, 3104 may also or alternatively be positioned in the rod 112 adjacent an end opposite the piston and beyond the end of the rod guide, which may include a bore 3106 for receiving one or more sensing elements 920 for sensing the field from the magnets 908c. In the embodiment of FIG. 31, the magnets 3102, 3104 are magnetized in direction parallel to the axis of the rod 112, as indicated by the arrows in FIG. 33.

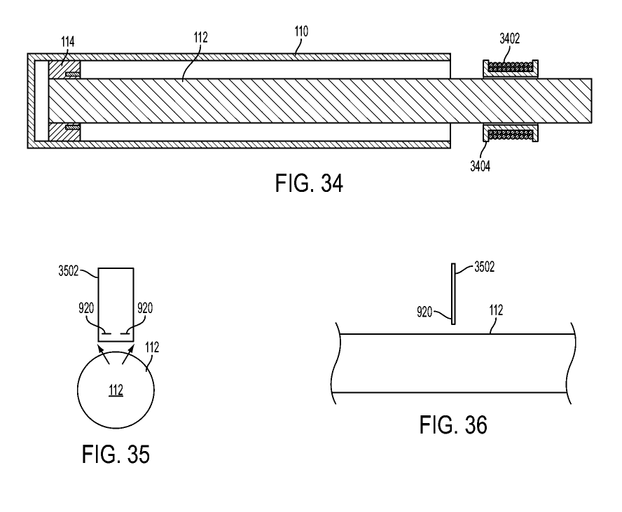

FIG. 34 illustrates an exemplary embodiment including a coil 3402 disposed on a coil holder 3404 around the rod 112. An AC current provided through the coil may be used to eliminate or reduce residual magnetization in the rod 112. In addition or alternatively, a DC biasing field may be applied to bias unwanted fields so that the desired field may be properly measured. Such a configuration may be used to bias or eliminate fields caused by, for example, a cow magnet. In an embodiment wherein the rod is coated with a hard magnetic coating or plating that is magnetically encoded, the coil may be used to erase or bias unwanted fields in the rod so the magnetic field stored in the hard coating can be properly measured.

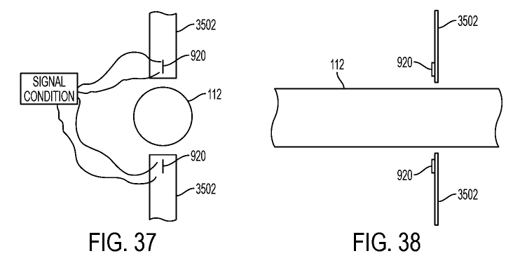

FIGS. 35-38 illustrate exemplary embodiments for positioning one or more sensors 920, e.g. flux gate sensors, adjacent the rod 112. As shown, the sensors 920 may be positioned on one or more printed circuit boards (PCB) 3502 e.g. in a slot in a rod guide 116 or separate sensor housing. The sensors 920 may be coupled in a differential configuration for cancelling common fields and enhancing the signal generated by flux from the magnets. FIGS. 35-36 illustrate a plurality of sensors 920 disposed on a single PCB oriented perpendicular to the rod 112. The sensors in FIGS. 35-36 are positioned on the PCB to extend across at least a portion of the width of the rod and generally perpendicular to the axis of the rod 112. FIGS. 37-38 illustrate sensors 920 disposed on separate PCBs oriented perpendicular to the rod and positioned 180 degrees around the circumference of the rod from each other. The sensors in FIGS. 37-38 are positioned on the PCBs to extend generally radially relative to the rod 112. Other sensor and PCB configurations may be used depending on the desired sensor output.

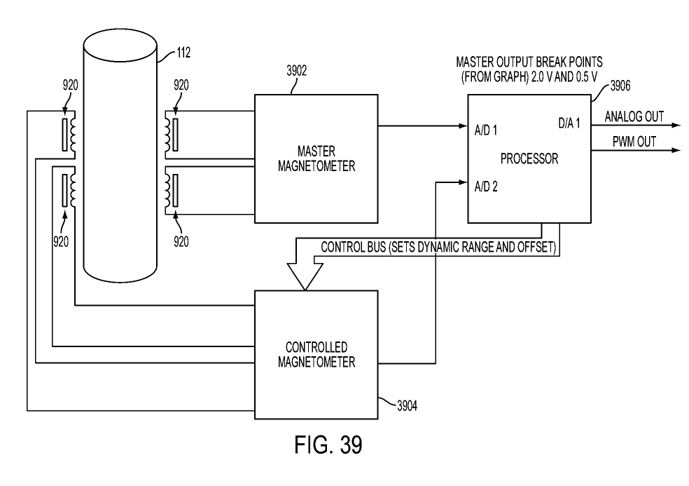

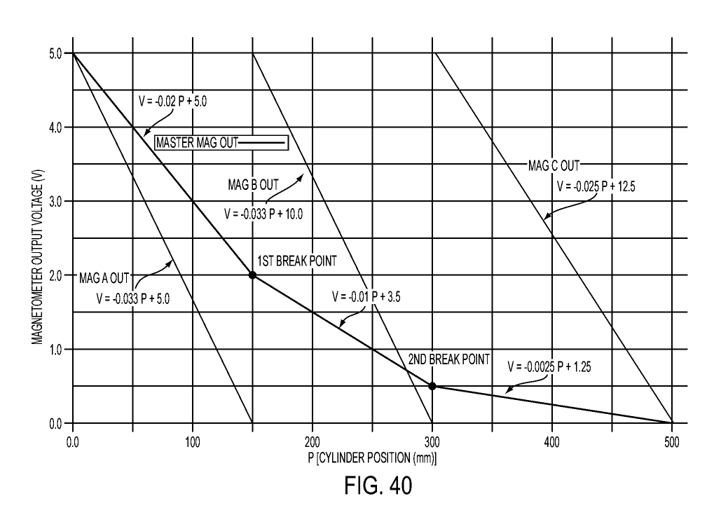

FIG. 39 illustrates, in block diagram form, exemplary electronics associated with a plurality of sensors 920 for providing an output indicative of the position of a rod useful in a system consistent with the present disclosure. The illustrated exemplary embodiment includes a master magnetometer 3902, a controlled magnetometer 3904 and a processor 3906. The controlled magnetometer 3902 may be configured to drive the sensors, e.g. fluxgate coils, in an automatic gain control configuration, e.g. in response to a control signal from the processor that sets the dynamic range and offset. This configuration may be used to provide output portioning to linearize the sensor outputs within defined cylinder position ranges. FIG. 40, for example, includes exemplary plots of the master 3902 and controlled magnetometer 3904 outputs vs. cylinder position, illustrating linearization of the sensor outputs within defined cylinder position ranges.

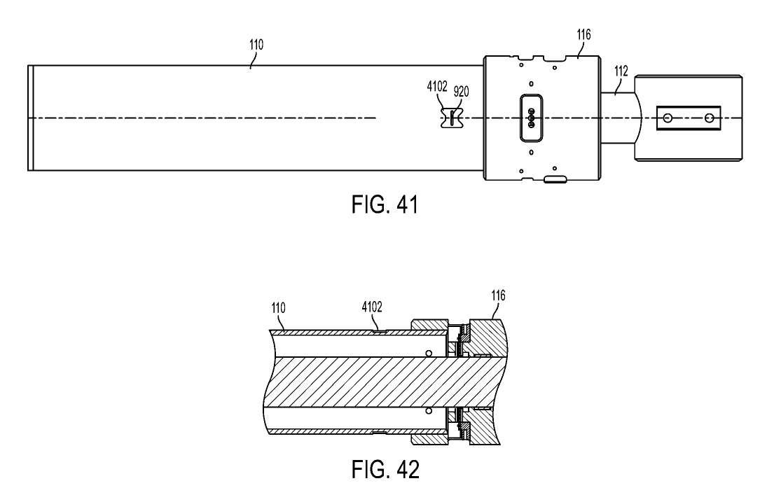

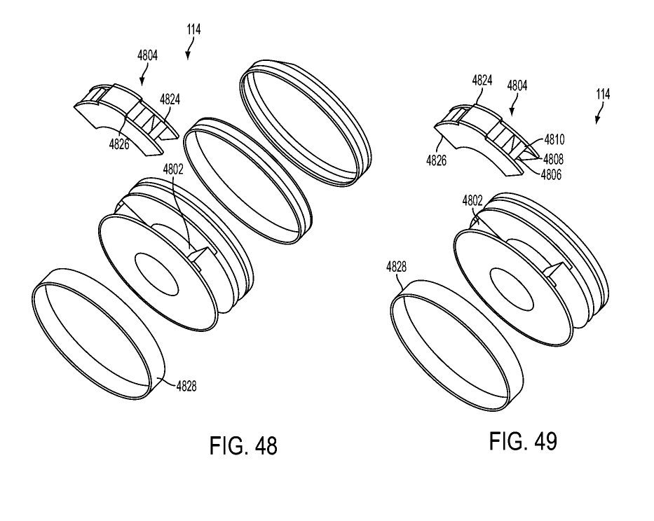

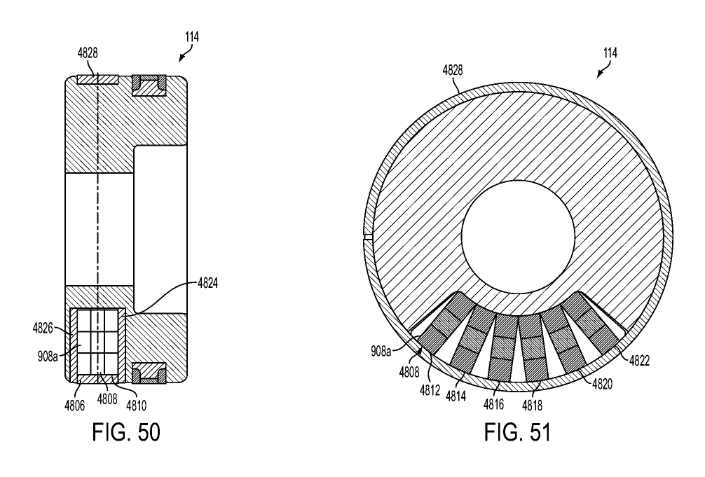

FIGS. 41-67 illustrate additional embodiments of a cylinder positions sensor consistent with the present disclosure. In general the embodiments illustrated in FIGS. 41-67 incorporate one or more sensors, e.g. flux gate sensors, disposed along the barrel 110 for sensing fields emanating from one or more permanent magnets, e.g. coupled to the piston 114.

FIGS. 41-42, for example, illustrate an exemplary embodiment consistent with the present disclosure, wherein a pocket 4102 is formed in the exterior surface of the barrel for receiving a sense element 920 tangentially oriented relative to the barrel, i.e. extending perpendicular to the barrel axis (the axis of motion) and across the barrel width on a surface of the barrel. Although the illustrated exemplary embodiment illustrates a single pocket 4102 with a single sense element therein, it is to be understood that any number of pockets and sense elements may be provided. Also, multiple sense elements may be provided in a single pocket and/or the sense elements may be provided in any orientation, e.g. tangential, axial, tangential at an oblique angle, etc. In any embodiment, flux through the sense element may be increased by providing ferromagnetic flux concentrators on either side of the pocket 4102 to direct flux through the sense element 920.

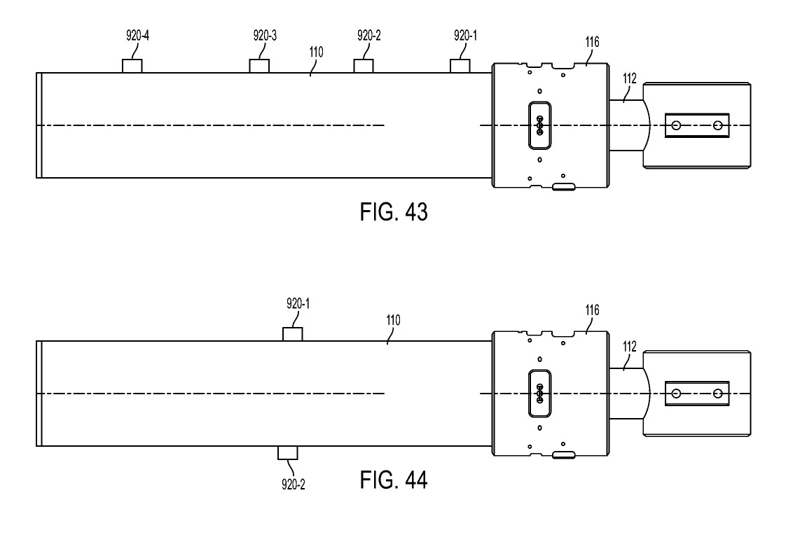

FIG. 43 illustrates another exemplary embodiment wherein an array of sense elements, 920-1, 920-2, 920-3, 920-4, is positioned along the length of the exterior of the barrel. Again any number of sense elements 920 may be used and in any orientation or combination of orientations. Also, the sense elements in the illustrated embodiment are shown to be generally equally spaced from each other along the length of the barrel. The sense elements may, however, be unequally spaced. For example, sense elements may be spaced relatively close together in areas of the barrel where high resolution is of interest, and spaced further apart in areas where low resolution is acceptable or desired.

FIG. 44 illustrates another exemplary embodiment, wherein first 920-1 and second 920-2 sense elements are disposed around the circumference of the barrel, e.g. 180 degrees apart from each other. As in any embodiment herein, the sense element outputs may be differentially combined to cancel external fields. Also, any number of sense elements may be provided in any orientation. Also, groups of circumferential sense elements may be provided in an array extending along the length of the barrel.

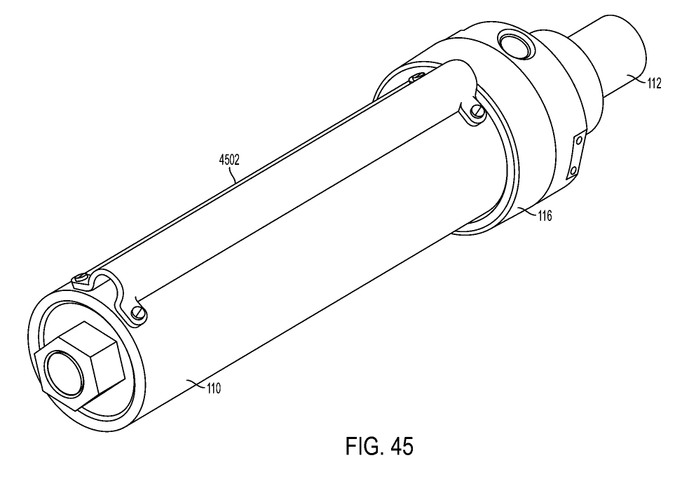

When sense elements are disposed on the exterior surface of the barrel 110, they may be exposed to damage resulting from environmental conditions. Also, external magnetic fields may contribute to the sensor output, thereby disrupting position sensing. To protect the sense elements, a shield may be provided over the sense elements. FIG. 45, for example, illustrates an elongate shield 4502 secured to an exterior surface of a barrel 110 to protect sense elements disposed on the barrel under the shield, e.g. as shown in FIG. 43. The shield may take any shape or configuration necessary for protecting the sense elements used in the application. Advantageously, the shield may provide mechanical protection, and may also at least partially shield the sense elements from external magnetic fields.

Coupling the magnets to the piston, rod, or nut, as described herein establishes a closed loop magnetic path for the flux from the magnets, e.g. through the piston, rod and the cylinder. Sensors placed at any location in, or adjacent to, this closed loop path may be used to sense flux from the magnets to determine cylinder/rod position. Any of the configurations described herein for coupling magnets to the piston or rod may, therefore, be used with sense elements disposed on the barrel.

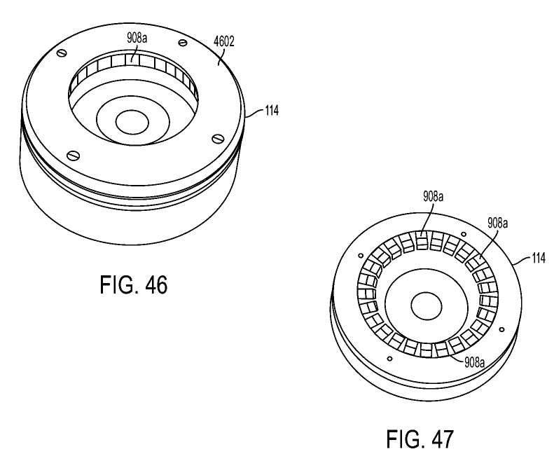

FIGS. 46-47 illustrate exemplary embodiment wherein a plurality of discreet magnets 908a are arranged around the circumference of a piston 114 in a pocket formed therein. The magnets are covered by a shield 4602 secured to an end of the piston 114. Providing magnets around the circumference of the piston may be useful maintaining proper position sensor output in cylinder configurations wherein the piston rod is required to rotate freely.

FIGS. 48-51 illustrate an exemplary embodiment consistent with the present disclosure wherein magnets are positioned only partially around the circumference of the piston. In the illustrated embodiment, an arcuate pocket 4802 is formed in the piston 114 for receiving a magnet assembly 4804. In the illustrated exemplary embodiment, the magnet assembly includes three separate magnet layers 4806, 4808, 4810. As shown, for example, in FIG. 51 with respect to layer 4608, each layer in the illustrated exemplary embodiment includes six stacks 4812, 4814, 4816, 4818, 4820 and 4822 of three magnets 908a each.

The magnet layers may be disposed between first 4824 and second 4826 arcuate plates and the magnet assembly may be fit into the arcuate pocket 4802. The assembly 4804 may be coupled to the piston by a retaining ring 4828 fit into a corresponding groove in the exterior surface of the piston. Although the illustrated embodiment shows a particular number and arrangement of magnets, it should be understood that any number of magnets may be used in any number of stacks.

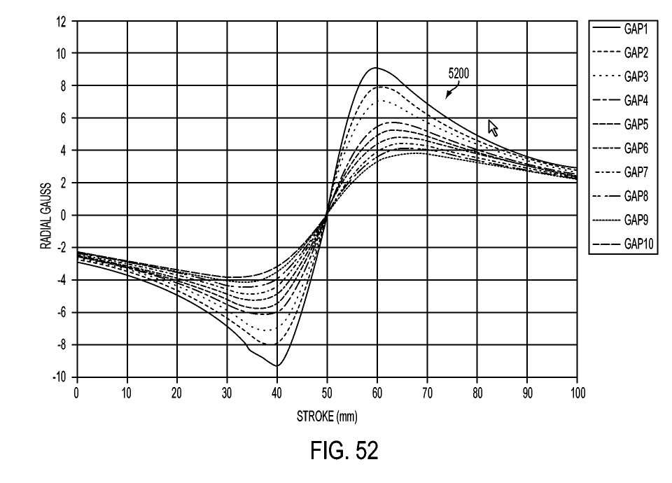

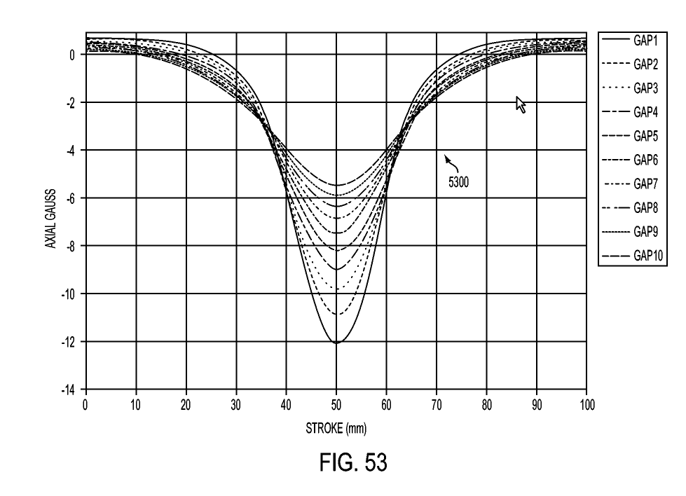

FIGS. 52 and 53 include plots of radial 5200 and axial gauss 5300, respectively, vs. rod position (stroke) for in a simulated cylinder position sensor system consistent with the present disclosure using sense elements disposed on the barrel and a piston including permanent magnets as illustrated in FIGS. 48-51. Plots are shown for different air gaps between the sense elements and the magnets. As shown, the sense elements provide an output that may be used to determine the position of the cylinder rod, and hence any movable element coupled thereto.

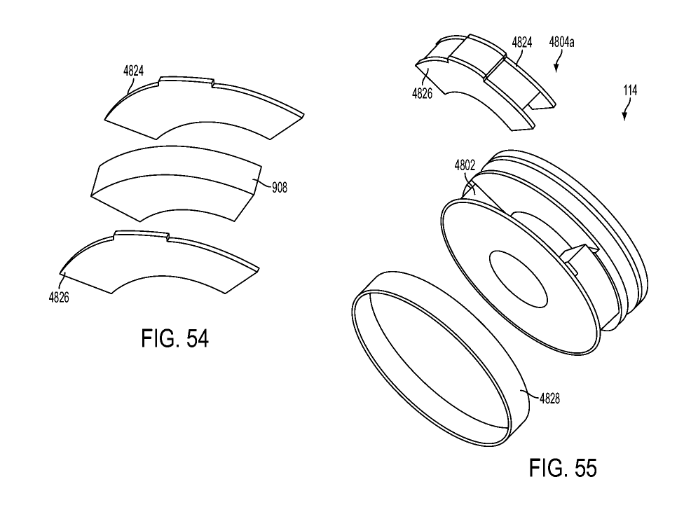

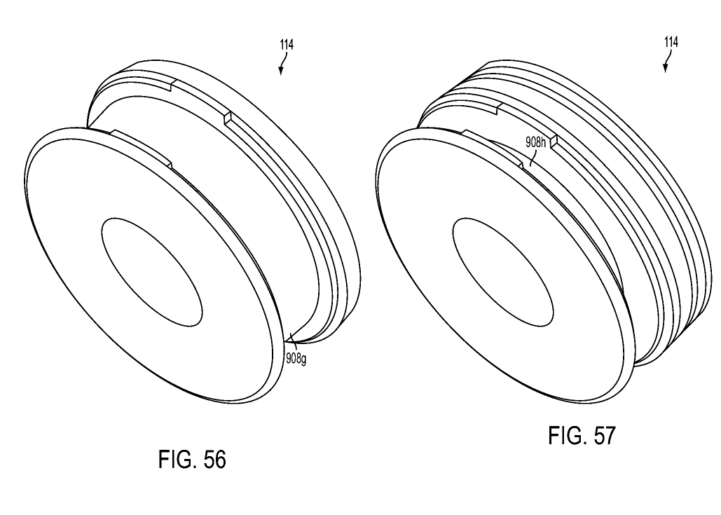

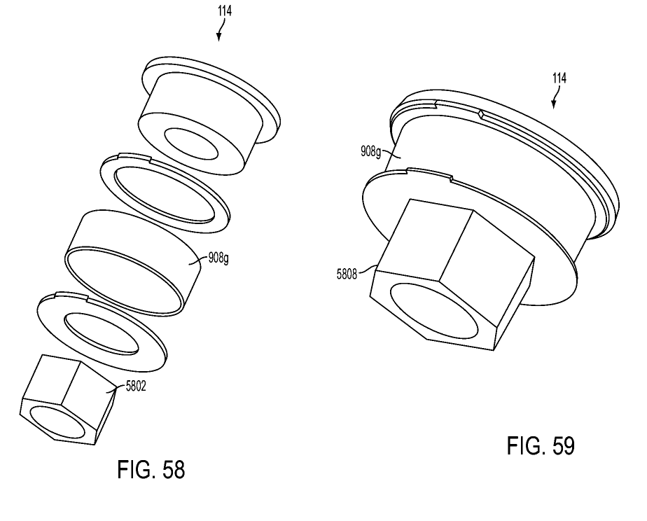

Other configurations for coupling permanent magnets to a piston 114 to generate sensible fields to indicate rod position are possible. For example, FIGS. 54-55 illustrate a magnet assembly 4804a including a single arcuate magnet 908 disposed between first 4824 and second 4826 arcuate plates. The assembly may be fit into a pocket 4802 in a piston and secured thereto by a retaining ring 4828 fit into a corresponding groove in the exterior surface of the piston. FIGS. 56-57 illustrate additional embodiments wherein a ring magnet 908g, 908h is disposed around the exterior surface of the piston. FIGS. 58-59 illustrate another embodiment wherein a ring magnet 908g may be secured to a piston using the nut 5802 that secures the piston 114 to the rod 112.

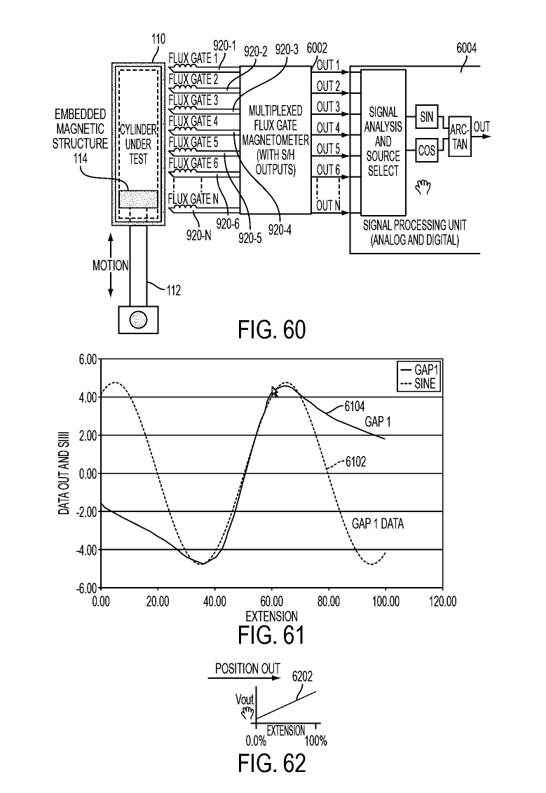

FIG. 60 illustrates exemplary electronics useful for obtaining cylinder position information from flux gate sensor elements 920-1, 920-2 . . . 920-N disposed on an exterior surface of the barrel 110 in an embodiment wherein one or more permanent magnets are coupled to the piston. The illustrated exemplary embodiment includes a fluxgate magnetometer 6002 coupled to the fluxgate sensor elements, and a signal processing unit 6004. The magnetometer 6002 monitors each of the flux gates and provides separate associated analog outputs representative of the flux imparted to the fluxgates to the signal processing unit. The signal processing unit may be configured to select a particular one of the outputs from the magnetometer.

Each output may be substantially sinusoidal over at least a portion of the rod stroke, i.e. the output varies with time and over the axial length of the rod stroke. FIG. 61, for example, shows a pure sinusoidal signal 6102 compared to an output 6104 of the magnetometer associated with an output of one of the sensor elements 920-1, 920-2 . . . 920-N. As shown, the sense element provides a nearly sinusoidal signal over a portion of the rod stroke (extension). The signal processing unit 6004 may receive the magnetometer outputs and may calculate the arctangent of sine/cosine (sine divided by cosine) flux gate outputs for selected sense elements to provide a voltage vs. stroke (rod position) characteristic 6202 that is substantially linear, as illustrated for example in FIG. 62. The substantially linear output characteristic of the signal processing unit may be used to determine rod position since discrete voltage levels are associated with each position of the rod in its stroke/extension.

A variety of configurations for the sensor electronics are possible. In general the electronics may incorporate one or more of the following aspects:

Differential measurement on tangential field to provide a thin package.

Tangential/radial or pure radial sense element configurations allow differential measurements to cancel common fields and enhance the underlying signal.

Multiple sense elements may be used to provide resolution and correct for run-out, bending. Three or four sense elements, for example, may be provided around the rod to average the signals with the same set of electronics centralized.

Diagnostics for abnormal magnetic fields.

Flux gate coil sense elements may be used for temperature sensing since their resistance changes with temperature.

Output partitioning and linearizing of sensor output may be accomplished, e.g. by driving in an automatic gain control configuration.

The system may use 12V instead of 5V as input voltage to increase the dynamic range and provide enhanced resolution.

The system may use differential measurements to de-couple the Earth's field that is attracted to the cylinder steel construction.

Axial and tangential field outputs may be combined to obtain a sinusoidal output.

The system may use a sin/cos and arctan algorithm to eliminate magnet aging effects.

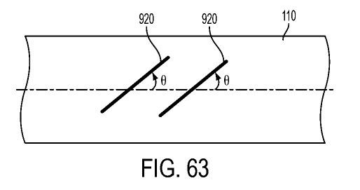

Obtaining a sinusoidal output from the sense elements may be helpful in calculating the arctangent of the sine/cosine to achieve a linear output. Turning to FIG. 63, it has been found that orienting the sense elements 920 tangentially to the barrel 110 and at an oblique angle θ to the axis of the barrel results in an improved sinusoidal output compared to a tangential sense element configuration wherein the sense elements are disposed perpendicularly to the barrel axis. In one embodiment, the sense elements 920 may be coupled as a differential pair and the angle θ may be 45 degrees. In one embodiment, the differentially connected sense elements may be spaced along the length of the barrel axis by about 25 mm.

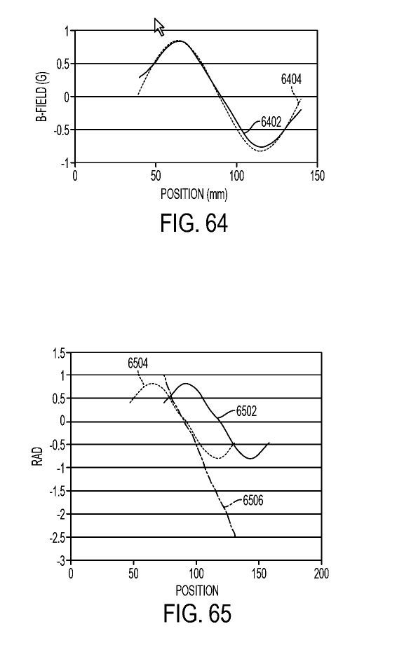

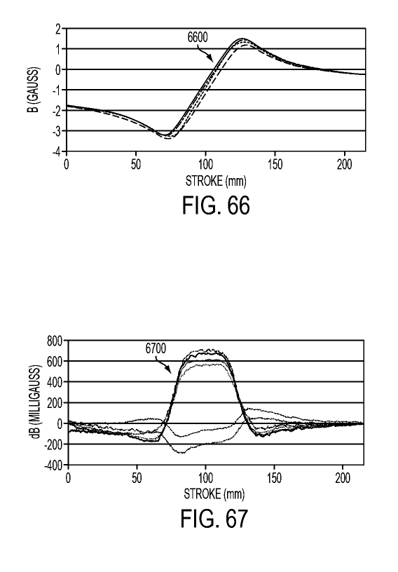

FIGS. 64-67 illustrate performance of a configuration consistent with FIG. 63 including one differential pair of sense elements at angle θ of 45 degrees. FIG. 64 includes a plot 6402 of sense element output vs. rod position/stoke along with a plot 6404 of a pure sinusoidal signal. As shown, the output associated with a differential pair of sense elements at angle θ of 45 degrees is substantially sinusoidal over a broad range of rod positions. FIG. 65 includes plots of sine 6502 and cosine 6504 outputs derived from a differential pair of sense elements at angle θ of 45 degrees, along with a plot of the arctangent 6506 of the sine/cosine (sine divided by cosine). As shown, the arctangent is substantially linear over a range of rod positions. FIG. 66 includes plots 6600 of sense element output vs. rod position/stoke associated with different rod stroke speeds showing the effect of eddy currents, and FIG. 67 includes plots 6700 of the derivative of the sensed field with respect to position indicating a strong sensed signal useful for correcting eddy current effects.

A system including sensors provided on the exterior of the barrel 110 may be used with a single sensor or an array of sensors including two or more sensors. An array of sensors positioned along the length of the barrel may provide more position information compared to a single point measurement. Also, when fluxgate sensors are used, a sensor array may be used with centralized electronics. Earth's fields can be managed using differential measurements and a barrel signature. The configuration is also scalable to any length of cylinder, and can be modified through appropriate placement of the sensors to sense only a particular of region of the cylinder. Variable resolution through piston travel can also be accommodated by proper spacing of sensors. Also, rotating fields sensed by the sensors resulting from travel of the piston enables use arctan of the sin/cos for canceling temperature, placement and aging variation in the magnets, and allows the magnets to be at different temperatures and have lower cost (hydraulic fluid warming up while ambient is cold may cause variation in magnet temperature). In essence, if the amplitude of the sine and cosine change due to temperature, placement or aging of the magnets and/or the sensor, the ratio of sin/cos stays the same, and the arctan of sin/cos provides the same value used for determining position.

Furthermore, such a system may not depend on the cylinder construction, material or assembly method, and may provide minimized tare length, e.g. no change in tare length. The additional information through travel may enable additional diagnostics and the system may not be susceptible to magnetic “bumps.” Every stroke may provide a magnetic erasing function overcoming any cow magnet issue, and with proper air gap management is possible to use a steel or non-ferrous piston. Also, the shield can be used to protect the connector coming out of the sensors, the connector can come out of the cylinder end to minimize wire routing and potential damage to wires, there may be no need to have additional coils for a “staggered” transfer function, and there may be no hydraulic intrusion.

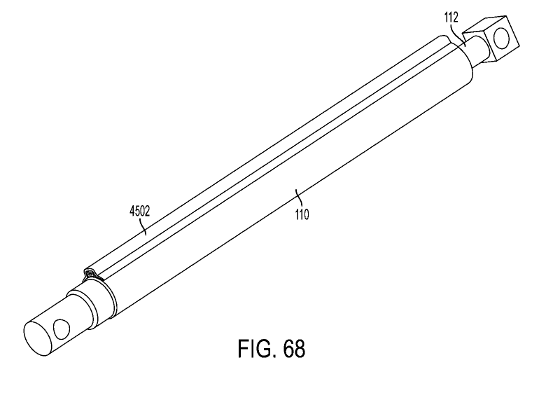

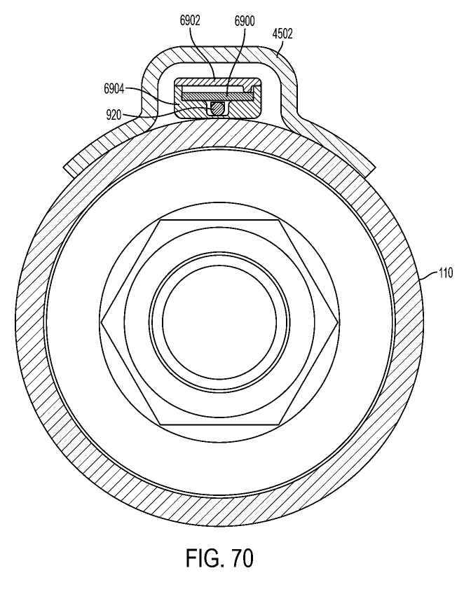

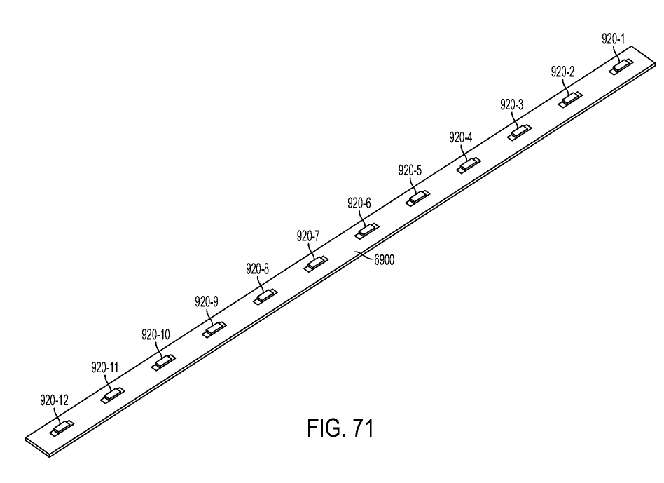

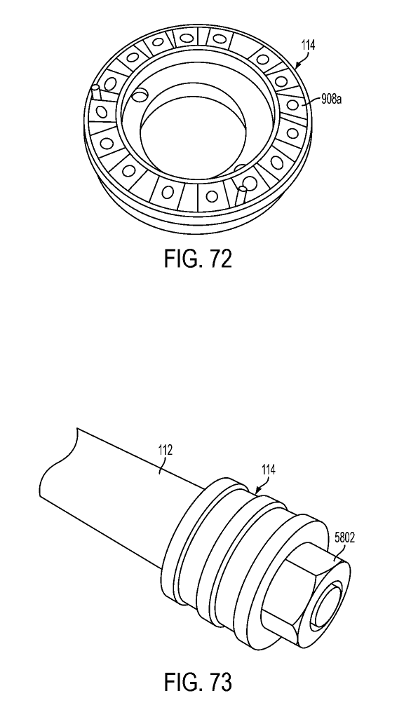

FIGS. 68-81 illustrate the construction and performance of an additional embodiment of a cylinder position sensor consistent with the present disclosure wherein sense elements 920 are provided at the exterior of the barrel 110 along the length thereof for sensing fields emanating from one or more permanent magnets, e.g. coupled to the piston 114.

In the illustrated exemplary embodiment, a shield 4502 is provided over an array of sense elements 920 disposed on a printed circuit board (PCB) 6900. The PCB and sense elements are at least partially enclosed within a housing including top 6902 and bottom 6904 housing portions. In the illustrated exemplary embodiment, the sense elements are coupled to a single PCB 6900. It is to be understood, however, the multiple separate PCBs may be provided for carrying the sense elements and associated electronics and/or conductive traces.

Again any number of sense elements 920 may be used and in any orientation or combination of orientations. Also, the sense elements in the illustrated embodiment are shown to be generally equally spaced from each other along the length of the barrel. The sense elements may, however, be unequally spaced. For example, sense elements may be spaced relatively close together in areas of the barrel where high resolution is of interest, and spaced further apart in areas where low resolution is acceptable or desired. Also, the shield 4502 may take any shape or configuration necessary for protecting the sense elements used in the application. Advantageously, the shield may provide mechanical protection, and may also at least partially shield the sense elements from external magnetic fields.

Coupling the magnets to the piston, rod, or nut, as described herein establishes a closed loop magnetic path for the flux from the magnets, e.g. through the piston, rod and the cylinder. Sensors placed at any location in, or adjacent to, this closed loop path may be used to sense flux from the magnets to determine cylinder/rod position. Any of the configurations described herein for coupling magnets to the piston or rod may, therefore, be used with sense elements disposed on the barrel.

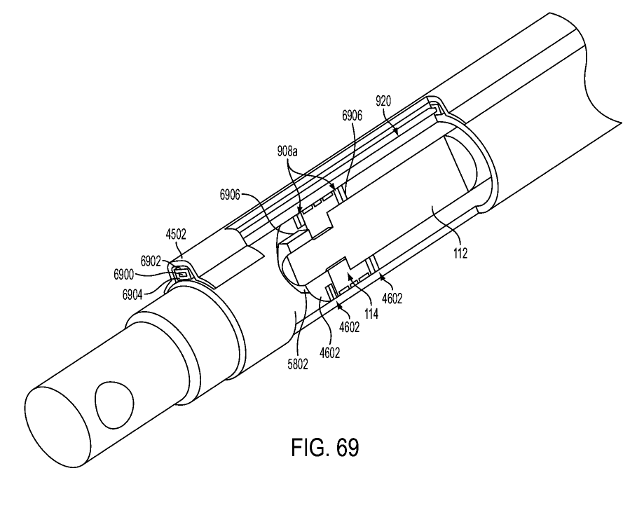

FIGS. 69 and 72-73 illustrate an exemplary embodiment wherein a plurality of discreet magnets 908a is arranged around the circumference of a piston 114 at the ends thereof. The magnets are covered by a shield 4602 secured to an end of the piston 114. Providing magnets around the circumference of the piston may be useful maintaining proper position sensor output in cylinder configurations wherein the piston rod is required to rotate freely. In addition, the shield 4602 may be configured to leave a space 6906 between shield and the piston rod and/or nut to allow hydraulic fluid to enter the cavity between the shield and piston in which the magnets are disposed. Hydraulic fluid may enter the cavity and metallic particles within the fluid may be attracted to the magnets for removing the particles from the fluid. In this way, the magnets may act as a filter for the fluid for removing metallic particles therefrom and preventing potential damage to the cylinder by the particles. Although the illustrated exemplary embodiment includes a space 6906, the magnets may provide a filtering effect in the absence of a space provided between the shield and the piston rod and/or nut 5802.

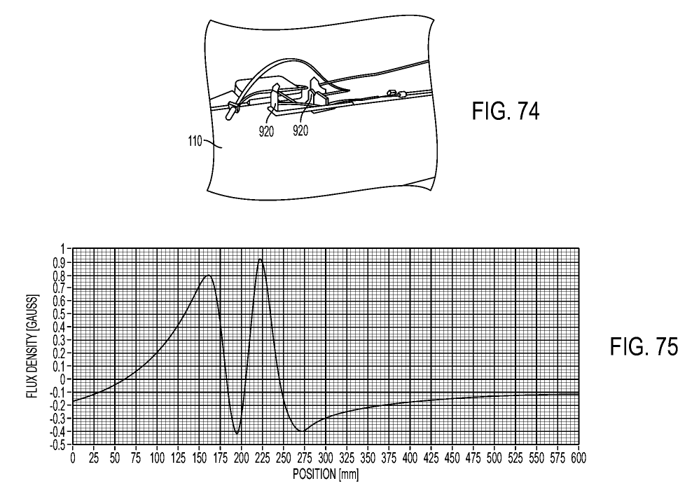

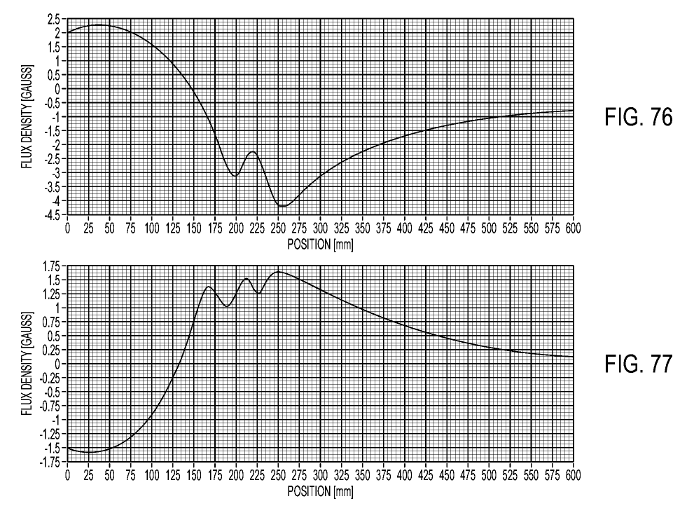

FIG. 74 illustrates an exemplary arrangement for sensing a radial field and FIGS. 75-77 include plots of radial gauss vs. rod position (stroke) in a simulated cylinder position sensor system consistent with the present disclosure using sense elements disposed on the barrel and a piston including permanent magnets as illustrated in FIGS. 68-73. FIG. 76 illustrates radial gauss vs. rod position for a first one (C1) of the sense elements 920 shown in FIG. 74, and FIG. 77 illustrates radial gauss vs. rod position for a second one (C2) of the sense elements shown in FIG. 74. FIG. 75 is a plot showing the C1-C2. As shown, the sense elements provide an output that may be used to determine the position of the cylinder rod, and hence any movable element coupled thereto.

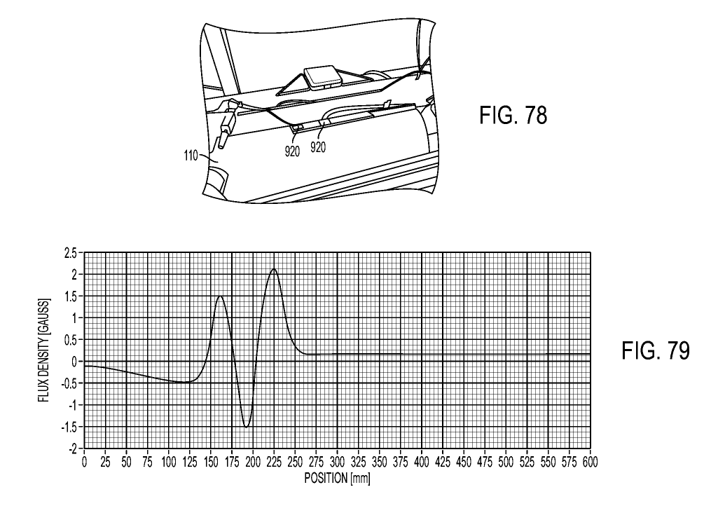

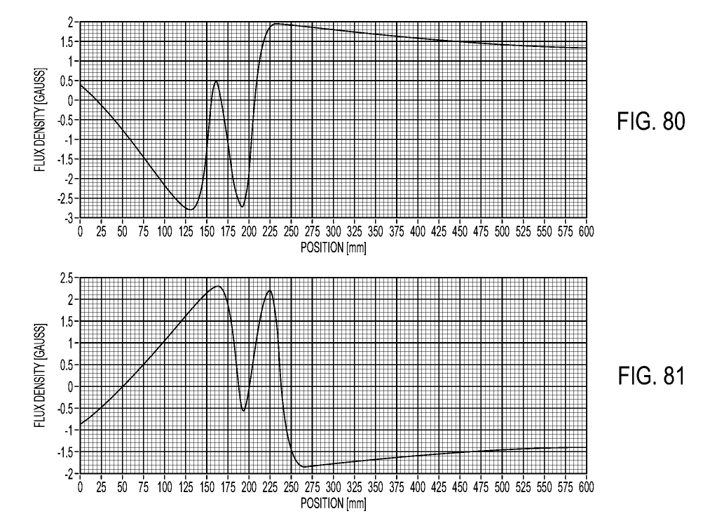

FIG. 78 illustrates an exemplary arrangement for sensing a radial field and FIGS. 79-81 include plots of axial gauss vs. rod position (stroke) in a simulated cylinder position sensor system consistent with the present disclosure using sense elements disposed on the barrel and a piston including permanent magnets as illustrated in FIGS. 68-73. FIG. 80 illustrates axial gauss vs. rod position for a first one (C1) of the sense elements 920 shown in FIG. 78, and FIG. 81 illustrates radial gauss vs. rod position for a second one (C2) of the sense elements shown in FIG. 78. FIG. 79 is a plot showing the C1-C2. As shown, the sense elements provide an output that may be used to determine the position of the cylinder rod, and hence any movable element coupled thereto.

A cylinder position sensor as shown and described in connection with FIGS. 68-81 may provide several features, including, for example:

the configuration may allow piston assembly without adding extra length to cylinder;

the configuration may allows use of existing piston material (steel) or other material like stainless steel;

magnetic poles of the magnets may face each other thereby forcing a concentrated large amount of field to come through barrel and be sensed

the configuration allows sense elements to be sitting axially and reduce overall size;

the configuration allows use of sin/cos to resolve position via arc-tan function

the configuration may use of magnetic shield that also serves as mechanical protection; and

the configuration may use permanent magnets and recess features to attract fine metallic objects in hydraulic fluid and provide a filter function.

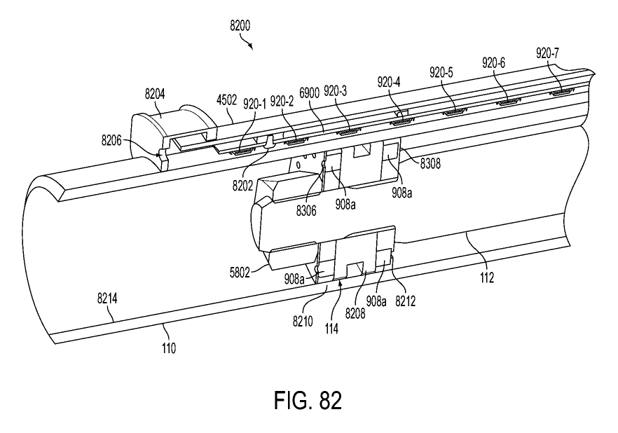

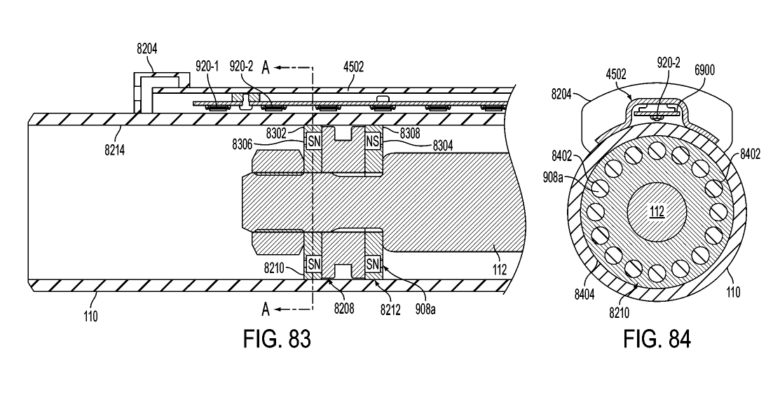

FIGS. 82-84 illustrate the construction and performance of another embodiment 8200 of a cylinder position sensor consistent with the present disclosure wherein sense elements 920 are provided at the exterior of the barrel 110 along the length thereof for sensing fields emanating from one or more permanent magnets 908a, e.g. coupled to a piston assembly 114. In one embodiment, the barrel 110 may be constructed from steel and the fields from the magnets 908a may be sensed through the steel barrel.

As shown, a shield 4502 may be provided over an array of sense elements 920-1 to 920-7 disposed on a printed circuit board (PCB) 6900. In the illustrated exemplary embodiment, the sense elements are flux gate sensors coupled to a single PCB 6900 in an axial configuration, i.e. the fluxgates have a longitudinal axis generally parallel to the longitudinal axis of the barrel. The PCB 6900 with the sense elements thereon is fastened to the shield 4502 using fasteners 8202, and end caps 8204 are positioned over the ends of the shield 4502 to substantially enclose the PCB 6900 between the shield, barrel and end caps. An opening 8206 may be provided in one or more of the end caps 8204 for passing electrical leads coupled to the PCB through the end cap.

Although a single PCB 6900 is shown, multiple separate PCBs may be provided for carrying the sense elements and associated electronics and/or conductive traces. Also, any number of sense elements 920 may be used and in any orientation or combination of orientations. The sense elements in the illustrated embodiment are shown to be generally equally spaced from each other along the length of the barrel 110. The sense elements may, however, be unequally spaced. For example, sense elements may be spaced relatively close together in areas of the barrel where high resolution is of interest, and spaced further apart in areas where low resolution is acceptable or desired. Also, the shield 4502 may take any shape or configuration necessary for protecting the sense elements used in the application. Advantageously, the shield may provide mechanical protection, and may also at least partially shield the sense elements from external magnetic fields.

In the illustrated exemplary embodiment, the piston assembly includes an inner piston 8208 disposed between first 8210 and second 8212 magnet holders is secured to the rod 112 by a nut 5802. The inner piston 8208 may be constructed from steel and may be a generally annular cylindrical member having a circumferential groove formed in an exterior surface thereof for receiving a seal and/or wear band. A central opening in the inner piston may be sized for receiving the rod 112.

Each magnet holder 8210, 8212 may be configured from a non-ferrous material, e.g. plastic, as a generally annular cylindrical plate including a plurality of pockets therein for receiving associated magnets 908a and a central opening for receiving the rod. As shown in the sectional view of FIG. 84, the pockets may be cylindrical pockets for receiving cylindrical magnets 908a. The exterior surfaces 8404 of the non-ferrous magnet holders may contact the interior surface 8214 of the barrel 110 as the piston assembly 114 moves therein to act as wear bands for providing reduced wear compared to contact of the inner piston surfaces with the barrel.

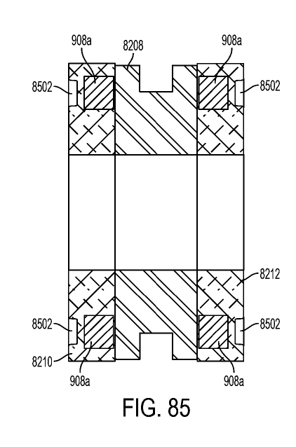

The end surfaces 8302, 8304 of the magnet holders may include one ore more openings 8306, 8308 therethrough that intersect with the pockets 8402. The openings may provide a space for receiving hydraulic fluid. Hydraulic fluid may enter the openings and metallic particles within the fluid may be attracted to the magnets for removing the particles from the fluid. In this way, the magnets 908a may act as a filter for the fluid for removing metallic particles therefrom and preventing potential damage to the cylinder by the particles. FIG. 85 illustrates and alternative configuration, wherein filter reservoirs 8502 are established by providing openings in the exterior surface of the magnet holders. In FIG. 85 the filter reservoirs do not extend through the magnet holders to intersect the magnet pockets. The magnets attract magnetic particles into the filter reservoirs to filter the particles from the fluid, but do not allow the particles into the interior seal area of the piston assembly.

The magnets 908a in one of the magnet holders may be magnetized with opposing magnetic fields or additive magnetic fields with respect to the magnets in the magnet holder on the opposite side of the piston. For example, and for ease of illustration, the magnets in the top portion of FIG. 84 show the magnets in respective magnet holders having opposing magnetic fields (north facing north) and the magnets in the bottom portion of FIG. 84 show the magnets in the respective magnet holders having additive (north facing south) magnetic fields. Normally, all of the magnets in the magnet holders would be configured having the same orientation, i.e. additive or opposing.

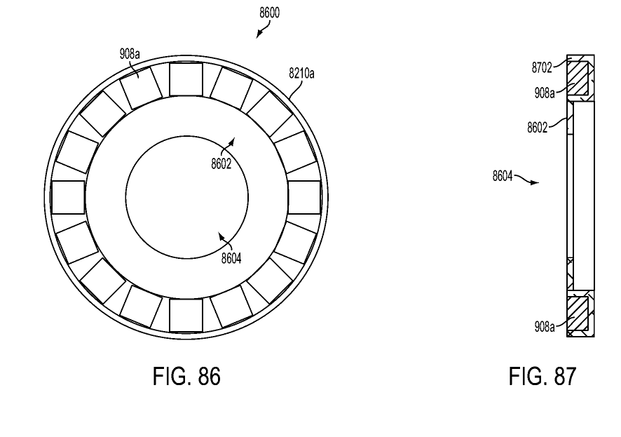

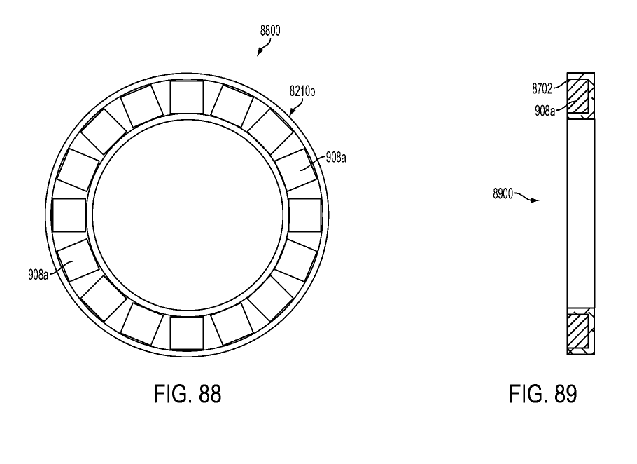

In FIGS. 82-85 the magnet holders 8208 and 8210 are shown as having a generally uniform cylindrical thickness with pockets therein for receiving the magnets and a central opening. FIGS. 86-91 illustrate alternative magnet holder configurations. FIGS. 86 and 87 illustrate an embodiment 8600 of a magnet holder 8210a having a generally annular shape with square pockets therein for receiving square magnets and a pinch shoulder portion 8602 disposed around a central opening 8604. The pinch shoulder portion 8602 may be compressed between the nut 5802 and the inner piston portion 8208 when the nut is secured to the rod 112, thereby securing the piston assembly to the rod. The configuration illustrated in FIGS. 86 and 87 may be provided on both sides of the inner piston portion, or may be provided only on the side that directly contacts the nut 5802. FIGS. 88 and 89 illustrate another embodiment 8800 of a magnet holder 8210b having a generally annular shape with square pockets 8702 therein for receiving square magnets 908a and large diameter central opening 8900. The magnet holder 8210b may be secured to the inner piston 8208 only by the magnetic attraction of the magnets therein to the piston material. No separate fasteners may be required to secure the magnetic holder 8210b to the piston.

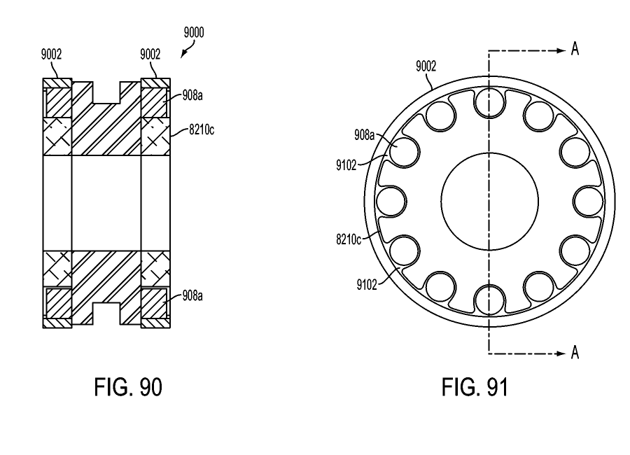

FIGS. 90 and 91 illustrate another embodiment 9000 of a magnet holder 8210c having a generally annular shape with generally u-shaped pockets 9102 in an exterior surface thereof. The magnets 908a are held in the pockets by annular wear bands 9002 fit over the exterior surface of the magnet holder, as shown. The wear bands 9002 may contact the interior surface of the barrel 110 as the piston assembly moves therein, and may provide low friction and reduced wear compared to contact of the inner piston surfaces with the barrel. In one embodiment, the wear bands 9002 may be constructed from a non-metallic, e.g. plastic, material. The wear bands 9002 allow for reduced air gap between the piston and the barrel, thereby providing increased signal strength and/or allowing use of fewer magnets number of magnets compared to a design including a portion of the non-ferrous magnet holder disposed between the magnets and the barrel.

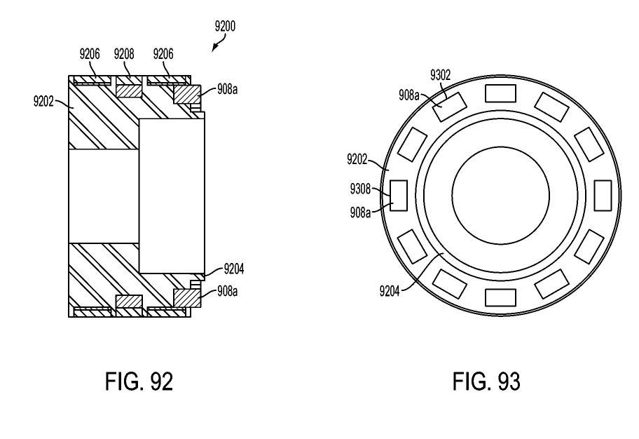

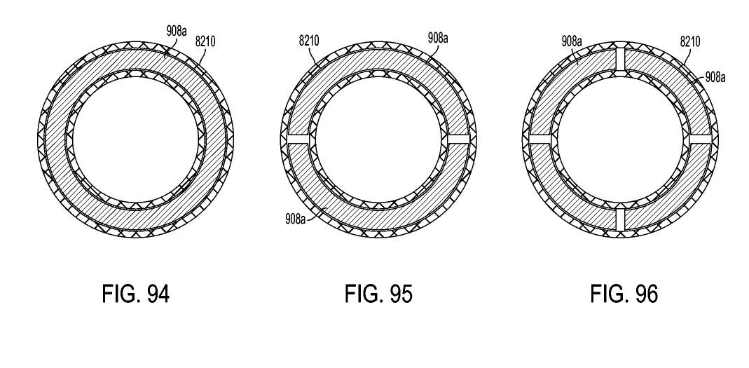

FIGS. 92 and 93 illustrate another embodiment 9200 of a piston assembly consistent with the present disclosure, wherein no separate magnet holder is required. In the illustrated embodiment, a plurality of pockets 9302 are provided in an end surface of a piston portion 9202 for receiving magnets 908a. The magnets may be held to the piston by the magnetic attraction between the magnets 908a and the piston material. The piston portion includes a stop portion 9204 that extends axially beyond an end surface of the magnets 908a to protect the magnets from contact with other elements, e.g. a nut, rod, etc. at the end of the travel of the piston assembly. The embodiment 9200 also includes circumferential slots formed in the exterior surface of the piston portion for receiving wear bands 9206 and a seal 9208.

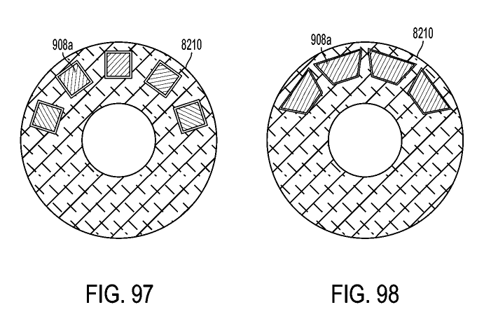

Although the illustrated embodiments include configurations with cylindrical and square magnet and pocket configurations, and the magnets extend around the circumference of the magnet holder or piston, it is to be understood that the pockets and magnets may be provided in any shape or combination of shapes and may extend around the entire circumference of the magnet holder or piston or any portion or portions thereof. FIGS. 95-102, for example, illustrate alternative magnet and pocket configurations. FIG. 95 illustrates a single ring magnet disposed in a single ring-shaped magnet holder pocket. FIG. 96 illustrates first and second arc magnets disposed in corresponding arc-shaped pockets, and FIG. 97 illustrates four arc magnets disposed in associated pockets. Providing a single magnet as shown in FIG. 95 or large magnet segments as shown in FIGS. 96 and 97, for example, as opposed to many small magnets, allows for increased field strength and reduced cost.

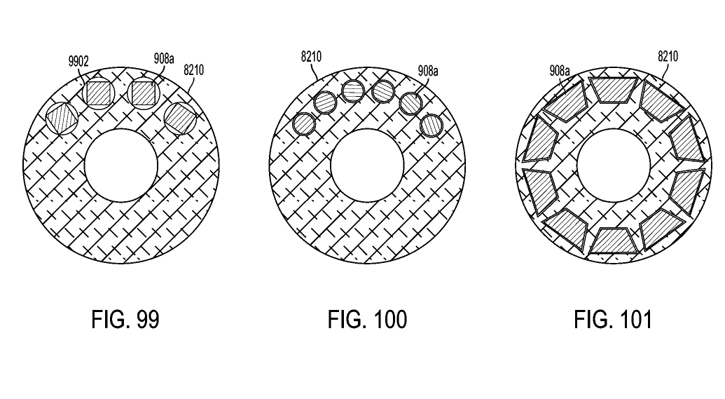

FIGS. 97-100 illustrate exemplary embodiments wherein an arc segment of a magnet holder 8210 includes magnet pockets for receiving associated magnets 908a. FIG. 97 illustrates an embodiment including square or cubical magnets 908a, and FIG. 98 illustrates an embodiment including trapezoidal magnets 908a. FIG. 99 illustrates an embodiment including cubical magnets 908a in cylindrical pockets 9902, and FIG. 100 illustrates an embodiment including cylindrical magnets in cylindrical pockets. If the cylinder rod 112 is keyed to the barrel 110 so that the cylinder is positioned in a known location relative to the barrel upon assembly, an arc segment of magnets may be used to allow fewer magnets and reduced cost. Otherwise, if the cylinder will be installed in an unknown rotational position relative to the barrel, it may be useful to provide one or more magnets around the entire circumference of the magnet holders or piston.

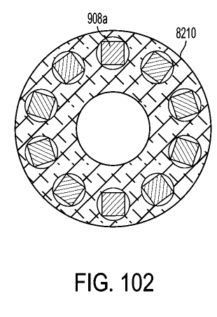

FIGS. 101 and 102 illustrate additional alternative configurations wherein magnets 908a are positioned around the entire circumference of the magnet holder 8210 or piston. FIG. 101 illustrates an embodiment including trapezoidal magnets 908a, and FIG. 102 illustrates an embodiment including square magnets 908a positioned in cylindrical pockets. In general, cylindrical magnets may be expensive to manufacture, but fit easily into corresponding cylindrical pockets. Cubical magnets may be inexpensive to manufacture since they may be ground from larger blocks, but assembling multiple cubical magnets next to each other can leave large gaps between the magnets and reduced fields. Trapezoidal magnets provide reduced gap, and may be less expensive to manufacture than round magnets.

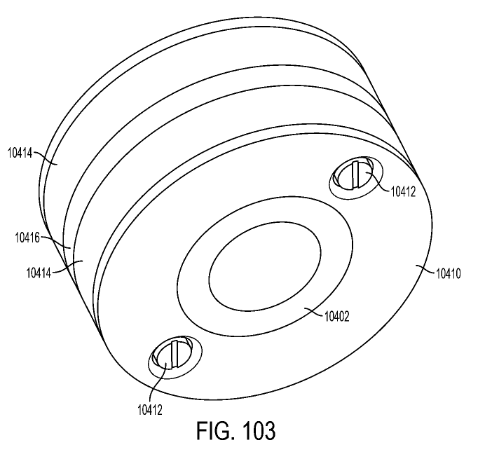

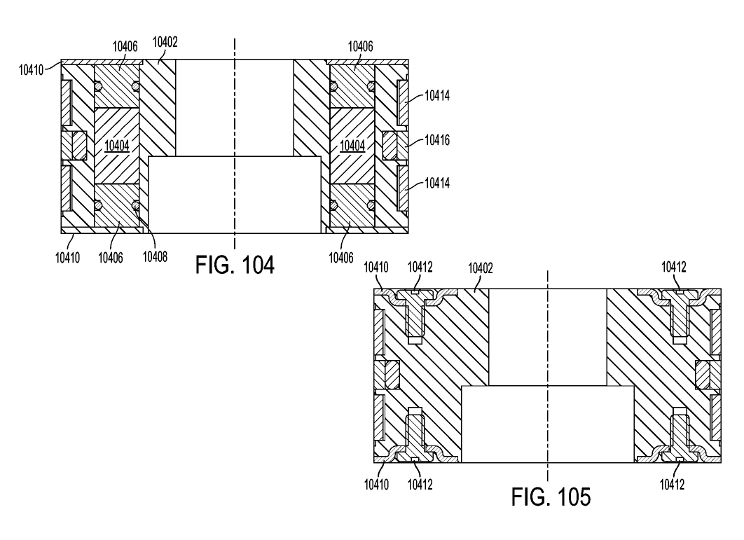

FIGS. 103-105 illustrate another embodiment of a piston assembly 10300 consistent with the present disclosure. The illustrated exemplary embodiment includes a piston body portion 10402 with magnet pockets extending axially therethrough. A magnet 10404 may be positioned in each of the pockets and a steel pole portion 10406 with an associated seal 10408 may be positioned on opposed sides of each magnet 10404, as shown for directing magnetic flux. The pockets may be closed by end caps 10410 poisoned on opposed ends of the body portion and secured to the body portion by fasteners 10412, such as screws. Wear bands 10414 and a seal 10416 may be provided in corresponding grooves in an exterior surface of the body portion.

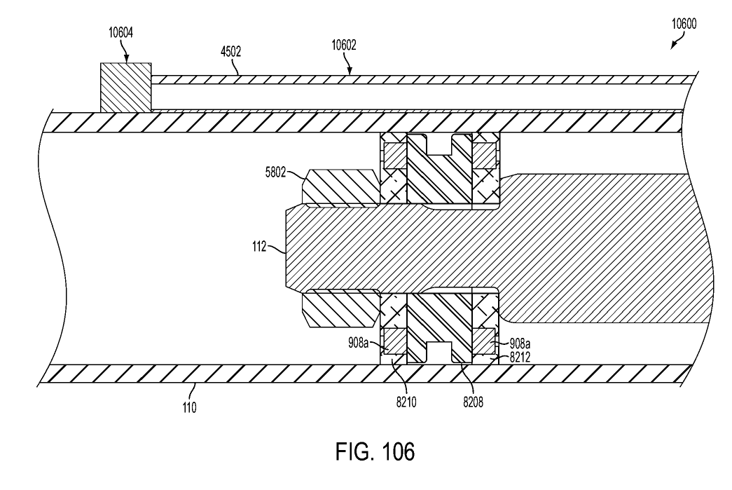

FIG. 106 illustrates another embodiment 10600 of a cylinder position sensor consistent with the present disclosure including a rod and piston assembly 114 as show in FIG. 82, but an alternative sense element configuration. In the illustrated exemplary embodiment, a one-piece sense element 10602 is positioned at the exterior of the barrel 110, e.g. on or adjacent to the barrel. The one-piece sense element may, for example, be constructed of a continuous nickel iron alloy strip. A shield 4502 is provided over the one-piece sense element 10602, and sensor electronics 10604 are provided at the end of the shield and enclose the sense element. In operation, the sensor electronics 10604 may provide an electrical pulse on the one-piece sense element 10602. The pulse may be reflected back to the electronics 10604 by the magnets 908a in the piston assembly 114. The location of the piston assembly 114 may therefore be established by known algorithms for calculating the time of flight of the pulse traveling from the electronics 10604 to the piston assembly 114 and back to the electronics. Knowing the time it takes for the pulse to travel to the piston and back to the electronics (time of flight) and the speed of travel for the pulse allows calculation of the location of the piston.

According one aspect of the disclosure there is provided a cylinder system including a cylinder barrel; a piston disposed within the cylinder barrel for reciprocating motion relative to the cylinder barrel; a piston rod coupled to the piston, the piston rod being configured to move axially relative to the barrel with the reciprocating motion of the cylinder; at least one magnet disposed within the cylinder barrel; at least one sense element positioned exterior to the barrel, the sense element being configured for providing an output in response to magnetic flux from the at least one magnet, the output varying with a position of the rod with respect to the cylinder barrel; and a shield coupled to the barrel and extending over the at least one sense element, the shield being configured to at least partially shield the at least one sense element from external magnetic fields.

According another aspect of the disclosure there is provided cylinder position sensor including: at least one magnet disposed within a cylinder barrel and providing magnetic flux in a flux path extending through a piston rod, a cylinder barrel, and a piston; and at least one sense element positioned exterior to the cylinder barrel, the sense element being configured for providing an output in response to the magnetic flux, the output varying with a position of the piston with respect to the cylinder barrel.

According to yet another aspect of the disclosure there is provided A cylinder system including: a cylinder barrel; a piston disposed within the cylinder barrel for reciprocating motion relative to the cylinder barrel; a piston rod coupled to the piston, the piston rod being configured to move axially relative to the barrel with the reciprocating motion of the cylinder; at least one magnet disposed within the cylinder barrel; at least one sense element positioned exterior to the barrel, the sense element being configured for providing an output in response to magnetic flux from the at least one magnet, the output varying with a position of the rod with respect to the cylinder barrel; and a demagnetizing coil disposed around the rod, the coil being configured for reducing residual magnetic fields in the rod caused by external magnetic fields upon energization of the coil.

The embodiments that have been described herein are but some of the several which utilize this invention and are set forth here by way of illustration, but not of limitation. Features or aspects of any embodiment described herein may be combined with any other feature or aspect of any other embodiment described herein to provide a system consistent with the present disclosure. It is obvious that many other embodiments, which will be readily apparent to those skilled in the art may be made without departing materially from the spirit and scope of the invention

What is claimed is:

1. A cylinder system comprising:
a cylinder barrel;
a piston disposed within said cylinder barrel for reciprocating motion relative to said cylinder barrel;
a piston rod coupled to said piston, said piston rod being configured to move axially relative to said barrel with said reciprocating motion of said cylinder;
at least one magnet disposed within said cylinder barrel;
at least one sense element positioned exterior to said barrel, said sense element being configured for providing an output in response to magnetic flux from said at least one magnet, said output varying with a position of said rod with respect to said cylinder barrel; and
a shield coupled to said barrel and extending over said at least one sense element, said shield being configured to at least partially shield said at least one sense element from external magnetic fields.

2. A system according to claim 1, wherein said at least one magnet is coupled to said piston.

3. A system according to claim 2, wherein said at least one magnet is coupled to a separate magnet carrier and said magnet carrier is coupled to said piston.

4. A system according to claim 2, said system comprising a plurality of said magnets.

5. A system according to claim 4, wherein each of said plurality of said magnets is coupled to a separate magnet carrier and said magnet carrier is coupled piston.

6. A system according to claim 1, said system comprising a plurality of said sense elements, said plurality of sense elements being positioned in an array adjacent an exterior surface of said barrel along the length thereof.

7. A system according to claim 1, said system comprising first and second ones of said sense elements coupled for providing a differential output.

8. A system according to claim 1, wherein said at least one sense element comprises a fluxgate sensor.

9. A system according to claim 1, said system further comprising at least one eraser magnet disposed adjacent said rod, said eraser magnet being configured for reducing residual magnetic fields in said rod caused by external magnetic fields.

10. A system according to claim 1, said system further comprising a demagnetizing coil disposed around said rod, said coil being configured for reducing residual magnetic fields in said rod caused by external magnetic fields upon energization of said coil.

11. A cylinder position sensor comprising:
at least one magnet disposed within a cylinder barrel and providing magnetic flux in a flux path extending through a piston rod, a cylinder barrel, and a piston; and
at least one sense element positioned exterior to said cylinder barrel, said sense element being configured for providing an output in response to said magnetic flux, said output varying with a position of said piston with respect to said cylinder barrel.

12. A system according to claim 11, wherein said at least one magnet is coupled to said piston.

13. A system according to claim 12, wherein said at least one magnet is coupled to a separate magnet carrier and said magnet carrier is coupled to said piston.

14. A system according to claim 12, said system comprising a plurality of said magnets.

15. A system according to claim 14, wherein each of said plurality of said magnets is coupled to a separate magnet carrier and said magnet carrier is coupled piston.

16. A system according to claim 11, said system comprising a plurality of said sense elements, said plurality of sense elements being positioned in an array adjacent an exterior surface of said barrel along the length thereof.

17. A system according to claim 11, said system comprising first and second ones of said sense elements coupled for providing a differential output.

18. A system according to claim 11, wherein said at least one sense element comprises a fluxgate sensor.

19. A system according to claim 11, said system further comprising a shield coupled to said barrel and extending over said at least one sense element, said shield being configured to at least partially shield said at least one sense element from external magnetic fields.

20. A cylinder system comprising:
a cylinder barrel;
a piston disposed within said cylinder barrel for reciprocating motion relative to said cylinder barrel;
a piston rod coupled to said piston, said piston rod being configured to move axially relative to said barrel with said reciprocating motion of said cylinder;
at least one magnet disposed within said cylinder barrel; and
at least one sense element positioned exterior to said barrel, said sense element being configured for providing an output in response to magnetic flux from said at least one magnet, said output varying with a position of said rod with respect to said cylinder barrel; and
a demagnetizing coil disposed around said rod, said coil being configured for reducing residual magnetic fields in said rod caused by external magnetic fields upon energization of said coil.
